(19) United States
(12) Patent Application Publication
(10) Pub. No.: US 2003/0081321 A1
(43) Pub. Date: May 1, 2003

(54) Optical cross-connect having an array of micro-mirrors

(75) Inventors: John A. Moon, Wallingford, CT (US); Alan D. Kersey, Glastonbury, CT (US); Jay W. Dawson, Livermore, CA (US); James R. Dunphy, Glastonbury, CT (US); Joseph Pinto, Wallingford, CT (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: CiDRA Corporation, Wallingford, CT (US)

(21) Appl. No.: 10/255,129

(22) Filed: Sep. 25, 2002

Related U.S. Application Data
(63) Continuation-in-part of application No. 10/115,647, filed on Apr. 3, 2002.
(63) Continuation-in-part of application No. 10/120,617, filed on Apr. 11, 2002.
(60) Provisional application No. 60/325,068, filed on Sep. 25, 2001.

(51) Int. Cl. G02B 27/10

(52) U.S. Cl. 359/619

(57) ABSTRACT

An optical cross-connect is provided that selectively switches at least one desired optical channel between a pair of optical WDM input signals. The cross-connect includes a spatial light modulator having a micro-mirror device with a two-dimensional array of micro-mirrors. The micro-mirrors tilt or flip between a first and second position in a “digital” fashion in response to a control signal provided by a controller in accordance with a switching algorithm and an input command. A pair of collimators diffraction gratings and Fourier lens collectively collimate, separate and focus the optical input channels and optical add channels onto the array of micro-mirrors. Each optical channel is focused on the micro-mirrors onto a plurality of micro-mirrors of the micro-mirror device, which effectively pixelates the optical channels. The optical channels have a cross-section (e.g., circular) to project as much of the beam as possible over the greatest number of micro-mirrors, while keeping the optical channels separated by a predetermined spacing. To selectively switch an optical channel between the optical input signals, a group of mirrors associated with each desired optical channel is tilted away from a return path to the second position. In an exemplary embodiment, the group of micro-mirrors reflects substantially all the light of each respective optical channel and does not reflect the light of any adjacent channels.

### CROSS REFERENCE TO RELATED APPLICATIONS

This application claims benefit to provisional patent application serial No. 60/325,068 (CC-0388), entitled “Optical Cross-connect Having an Array of Micromirrors”, filed Sep. 25, 2001, and is a continuation-in-part of patent application Ser. No. 10/115,647 (CC-0461), filed Apr. 3, 2002, as well as a continuation-in-part of patent application Ser. No. 10/120,617 (CC-0461), filed Apr. 11, 2002, which are all hereby incorporated by reference in their entirety.

This application filed concurrently with the same identified by Express mail nos. EV 137 071 802 US (CC-0544), EV 137 071 793 US (CC-0545), and EV 137 071 780 US (CC-0547), which are also hereby incorporated by reference in their entirety.

### BACKGROUND OF THE INVENTION

1. Technical Field

The present invention relates to a tunable optical device, and more particularly to a reconfigurable optical cross-connect including an array of micro-mirrors to selectively switch either no optical channels or one or more optical channels between a pair of input wavelength division multiplexing (WDM) optical signals.

2. Description of Related Art

Micro-electro-mechanical system (MEMS) devices have been widely explored and used for optical switching applications. The most commonly used application is for optical cross-connect switching. In most cases, individual micro-mirror elements are used to ‘steer’ a beam (i.e., an optical channel) to a switched port or to deflect the beam to provide attenuation on a channel-by-channel basis. Each system is designed for a particular ‘wavelength plan’—e.g. “X” number of channels at a spacing “Y”, and therefore each system is not ‘scalable’ to other wavelength plans.

In the networking systems, it is often necessary to route different channels (i.e., wavelengths) between one fiber and another. Many technologies can be used to accomplish this purpose, such as Bragg gratings or other wavelength selective filters.

One disadvantage of Bragg grating technology is that it requires many discrete gratings and/or switches, which makes a 40 or 80 channel device quite expensive. A better alternative would be to use techniques well-known in spectroscopy to spatially separate different wavelengths or channels using bulk diffraction grating technology. For example, each channel of a WDM signal is provided to a different location on a generic MEMS device. The MEMs device is composed of a series of tilting mirrors, where each discrete channel hits near the center of a respective mirror and does not hit the edges. In other words, one optical channel reflects off a single respective mirror.

One issue with the above optical MEMS device is that it is not “channel plan independent”. In other words, each MEMs device is limited to the channel spacing (or channel plan) originally provide. Another concern is that if the absolute value of a channel wavelength changes, a respective optical signal may begin to hit an edge of a corresponding mirror leading to large diffraction losses. Further, since each channel is aligned to an individual mirror, the device must be carefully adjusted during manufacturing and kept in alignment when operated through its full temperature range in the field.

It would be advantageous to provide an optical cross-connect that mitigates the above problems by using an array of micro-mirrors.

### SUMMARY OF THE INVENTION

An object of the present invention is to provide a reconfigurable optical cross-connect having a spatial light modulator that includes a micro-mirror device having an array of micro-mirrors, wherein a plurality of micro-mirrors direct the optical channels of the WDM input signals to selectively switch either no optical channels or one or more optical channels between a pair of optical WDM input signals, which advantageously permits the cross-connect to be reconfigurable by changing a switching algorithm that drives the micro-mirrors, without having to change the hardware configuration.

In accordance with an embodiment of the present invention, the optical cross-connect includes an optical arrangement for receiving two or more optical signals, each optical signal having one or more optical bands or channels, and including a spatial light modulator having a micro-mirror device with an array of micro-mirrors for reflecting the two or more optical input signals provided thereon. The optical arrangement features a free optic configuration having one or more light dispersion elements for separating the two or more optical signals so that each optical band or channel is reflected by a respective plurality of micro-mirrors to selectively switch the one or more optical bands or channels between the two optical signals.

The one or more light dispersion elements may include either a diffraction grating, an optical splitter, a holographic device, a prism, or a combination thereof. The one or more diffraction gratings may include a blank of polished fused silica or glass with a reflective coating having a plurality of grooves either etched, ruled or suitably formed thereon. The diffraction grating may also be tilted and rotated approximately 90° in relation to the spatial axis of the spatial light modulator.

The spatial light modulator may be programmable for reconfiguring the optical cross-connet by changing a switching algorithm that drives the array of micro-mirrors.

In one embodiment, the optical cross-connect comprises a first collimator that collimates a first optical input signal. The first optical input signal includes a plurality of optical input channels. Each optical input channel is centered at a central wavelength. A first light dispersion element is provided that substantially separates the optical input channels of the first collimated optical input signal. A second collimator collimates the second optical input signal. The second optical input signal includes a plurality of optical input channels. Each optical input channel is centered at a central wavelength. A second light dispersion element is provided that substantially separates the optical input channels of the second collimated optical input signal. A spatial light modulator reflects each separated optical input channel along a respective first optical path or second optical path; reflects at least one optical input channel of the second optical input signal along the respective first optical path; and reflects a corresponding at least one optical input channel of the first optical input signal along the respective second optical path in response to a control signal. The spatial light modulator comprises a micro-mirror device includes an array of micro-mirrors selectively disposable between a first and a second position in response to the control signal. Each separated optical input channel is incident on a respective group of micro-mirrors. Each separated optical input channel of the second optical input signal is incident on the respective group of micro-mirrors. Each respective separated optical input channel reflects along the respective first optical path when the micro-mirrors are disposed in the first position or along the respective second optical path. When the micro-mirrors are disposed in the second position, at least one optical input channel of the second optical input signal reflects along the respective first optical path when the micro-mirrors are disposed in the first position. A controller generates the control signal, in accordance with a switching algorithm.

Many other embodiments are shown and described.

### BRIEF DESCRIPTION OF THE DRAWING

The drawing, not drawn to scale, includes the following Figures:

FIG. 1 is a block diagram of a reconfigurable optical cross-connect;

FIG. 2A is a plan view of a block diagram of a reconfigurable optical cross-connect including a spatial light modulator in accordance with the present invention;

FIG. 2B is a side elevational view of a block diagram of the cross-connect of FIG. 2A;

FIG. 3 is a plan view of a block diagram of another embodiment of a cross-connect in accordance with the present invention;

FIG. 4A is a block diagram of a spatial light modulator of the cross-connect of FIG. 2A having a micro-mirror device, wherein the optical channels of a pair of WDM input signals are distinctly projected onto the micro-mirror device, in accordance with the present invention;

FIG. 4B is a block diagram of an alternative spatial light modulator having a micro-mirror device with mirrors tilting on a spectral axis that is perpendicular to the spectral axis of WDM input signal distinctly projected thereon in accordance with the present invention;

FIG. 5a is a pictorial cross-sectional view of the micro-mirror device of FIG. 4A showing a partial row of micro-mirrors, when the micro-mirrors are disposed in a first position perpendicular to the light beam of an input signal in accordance with the present invention;

FIG. 5b is a pictorial cross-sectional view of the micro-mirror device of FIG. 4B showing a partial row of micro-mirrors, when the micro-mirrors are disposed in a second position non-orthogonal to the light beam of an input signal in accordance with the present invention;

FIG. 6 is a plan view of a micro-mirror of the micro-mirror device of FIG. 4A in accordance with the present invention;

FIG. 7 is a block diagram of a spatial light modulator of the cross-connect of FIG. 4A, wherein four groups of micro-mirrors are tilted to selectively switch optical channels between a pair of WDM input signals, in accordance with the present invention;

FIG. 8A is a block diagram of another embodiment of a cross-connect including a spatial light modulator, in accordance with the present invention;

FIG. 8B is a block diagram of another embodiment of a cross-connect in accordance with the present invention;

FIG. 8C is a block diagram of another embodiment of a cross-connect in accordance with the present invention;

FIG. 9 is a block diagram of another embodiment of a cross-connect including a spatial light modulator, in accordance with the present invention.

FIG. 10 is a block diagram of a spatial light modulator of the cross-connect of FIG. 9 having a micro-mirror device, wherein the optical channels of a pair of WDM input signals are distinctly projected onto the micro-mirror device, in accordance with the present invention;

FIG. 11 is a block diagram of a spatial light modulator of the cross-connect of FIG. 9, wherein four groups of micro-mirrors are tilted to selectively switch four optical channels between a pair of WDM input signals, in accordance with the present invention;

FIG. 12 is a perspective view of a portion of a known micro-mirror device;

FIG. 13 is a plan view of a micro-mirror of the micro-mirror device of FIG. 12;

FIG. 14a is a pictorial cross-sectional view of the micro-mirror device of FIG. 12 showing a partial row of micro-mirrors, when the micro-mirrors are disposed in a second position non-orthogonal to the light beam of the pair of input signals in accordance with the present invention;

FIG. 14b is a pictorial cross-sectional view of the micro-mirror device of FIG. 12 showing a partial row of micro-mirrors, when the micro-mirrors are disposed in a first position perpendicular to the light beam of the pair of input signals in accordance with the present invention;

FIG. 15 is a pictorial cross-sectional view of the micro-mirror device of FIG. 12 disposed at a predetermined angle in accordance with the present invention;

FIG. 16 is a graphical representation of the micro-mirror device of FIG. 15 showing the reflection of the incident light;

FIG. 17a is a graphical representation of a portion of the optical filter wherein the grating order causes the shorter wavelengths of light to image onto the micromirror device that is closer than the section illuminated by the longer wavelengths, in accordance with the present invention;

FIG. 17b is a graphical representation of a portion of the optical filter wherein the grating order causes the longer wavelengths of light to image onto the micromirror device that is closer than the section illuminated by the shorter wavelengths, in accordance with the present invention;

FIG. 18A is a plan view of a block diagram of another embodiment of a cross-connect including a spatial light modulator in accordance with the present invention;

FIG. 18B is a plan view of a block diagram of another embodiment of a cross-connet in accordance with the present invention;

FIG. 19 is an expanded view of the micro-mirror device of the spatial light modulator of FIG. 18A, wherein the optical channels of a pair of WDM input signals are distinctly projected onto the micro-mirror device, in accordance with the present invention;

FIG. 20 is a graphical representation of the light of an optical channel reflecting off a spatial light modulator, wherein the light is focused relatively tight, in accordance with the present invention;

FIG. 21 is a graphical representation of the light of an optical channel reflecting off a spatial light modulator, wherein the light is focused relatively loose compared to that shown in FIG. 17, in accordance with the present invention;

FIG. 22 is a plan view of a block diagram of another cross-connect including a spatial light modulator having a micro-mirror device of FIG. 12, in accordance with the present invention;

FIG. 23 is a side elevational view of a block diagram of the cross-connect of FIG. 22;

FIG. 24 is a block diagram of a spatial light modulator of the cross-connect of FIG. 22 having a micro-mirror device, wherein the optical channels of a pair of WDM input signals are distinctly projected onto the micro-mirror device, in accordance with the present invention;

FIG. 25a is a pictorial cross-sectional view of the micro-mirror device of FIG. 12 showing a partial row of micro-mirrors, when the micro-mirrors are disposed in a first position, in accordance with the present invention;

FIG. 25b is a pictorial cross-sectional view of the micro-mirror device of FIG. 12 showing a partial row of micro-mirrors, when the micro-mirrors are disposed in a second position, in accordance with the present invention;

FIG. 26 is a plan view of a block diagram of another cross-connect including a spatial light modulator having a micro-mirror device of FIG. 3, in accordance with the present invention;

FIG. 27 is a plan view of a block diagram of another cross-connect including a spatial light modulator having a micro-mirror device of FIG. 3, in accordance with the present invention;

FIG. 28 is a plan view of a block diagram of another cross-connect including a spatial light modulator having a micro-mirror device of FIG. 3, in accordance with the present invention;

FIG. 29 is a block diagram of another embodiment of a cross-connect including a plurality of cross-connects using a single spatial light modulator, in accordance with the present invention;

FIG. 30 is a block diagram of the spatial light modulator of the cross-connect of FIG. 26, wherein the optical channels of a plurality of WDM input signals are distinctly projected onto the micro-mirror device, in accordance with the present invention;

FIG. 31 is a block diagram of a spatial light modulator of the cross-connect of FIG. 26, wherein groups of micro-mirrors are tilted to selectively switch optical channels between a pair of a WDM input signals, in accordance with the present invention;

FIG. 32A is an exploded view of a collimator assembly according to the present invention;

FIG. 32B is an exploded view of a fiber array holder subassembly that forms part of the collimator assembly shown in FIG. 32A;

FIGS. 32C and 32D are exploded views of a fiber V-groove subassembly shown in FIG. 32B;

FIG. 32E is a view of a constructed collimator assembly shown in FIG. 32A;

FIG. 33 shows an alternative embodiment of a cross-connect having one or more optic devices for minimizing polarization dispersion loss (PDL);

FIG. 34 shows an embodiment of a cross-connect having a chisel prism in accordance with the present invention;

FIG. 35 shows an alternative embodiment of a cross-connect having a chisel prism in accordance with the present invention;

FIG. 36 shows an alternative embodiment of a cross-connect having a chisel prism in accordance with the present invention;

FIG. 37 is side elevational view of a portion of the optical channel filter of FIG. 36;

### DETAILED DESCRIPTION OF THE INVENTION

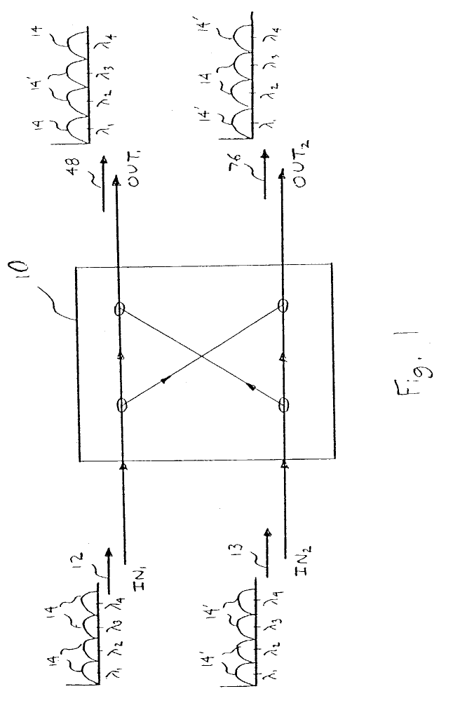

### FIGS. 1-7: The Basic Invention

FIGS. 1-7 show an embodiment of the basic invention which features the optical cross-connect generally indicated as 10 having an optical arrangement 15, 16 for receiving two or more optical input signals 12, 13, each optical input signal having one or more optical bands or channels, and including a spatial light modulator 30 having a micro-mirror device 82 (FIGS. 3-7) with an array of micro-mirrors 84 for reflecting the optical input signals provided thereon. The optical arrangement 15, 16 features a free optic configuration having one or more light dispersion elements 24, 54 for separating the optical input signals 12, 13 so that each optical band or channel is reflected by a respective plurality of micro-mirrors 100, 101, 102, 103 (FIG. 7) to selectively switch either no optical bands or channels, or one or more optical bands or channels, between the two or more optical signals 12, 13 in order to provide two optical output signals 48, 76.

The optical arrangement 15, 16 includes a first optical portion 15 and a second optical portion 16 that provide the optical input signals 12, 13 to the spatial light modulator 30, and also provide from the spatial light modulator 30 the optical output signal 48, 76 having the cross-connected optical bands or channels after bands or channels have been switched between the one or more optical signals. The scope of the invention is not intended to be limited to any particular type of optical portion. Embodiments are shown and described by way of example below having many different types of optical portions. The scope of the invention is not intended to be limited to only those types of optical portions shown and described herein.

The spatial light modulator 30 may be programmable for reconfiguring the cross-connect 10 by changing a switching algorithm that drives the array of micro-mirrors 84.

In FIG. 1, the cross-connect 10 receives a pair of WDM input signals 12, 13 and selectively switches either at least one or more optical band or channel 14, 14′, respectively, between the input signals to provide a pair of modified output signals 48, 76. Each optical channel 14, 14′ (or wavelength band of light) is centered at a respective channel wavelength (λ₁, λ₂, λ₃, . . . , λ_{N}). In one embodiment, as shown, one input signal 12 includes optical channels 14 (e.g., at λ₁-λ₄), and the other input signal 13 includes optical channels 14′ (e.g., at λ₁-λ₄). The cross-connect 10 in response to an input signal and switching algorithm switches the second and third channels at λ₂, λ₃ between the input signals 12, 13 to provide the output signals 48, 76. While the invention is described as switching at least one optical band or channel, one will recognize that te cross-connect device 10 may be commanded to switch no optical bands or channels between the optical input signals 12, 13.

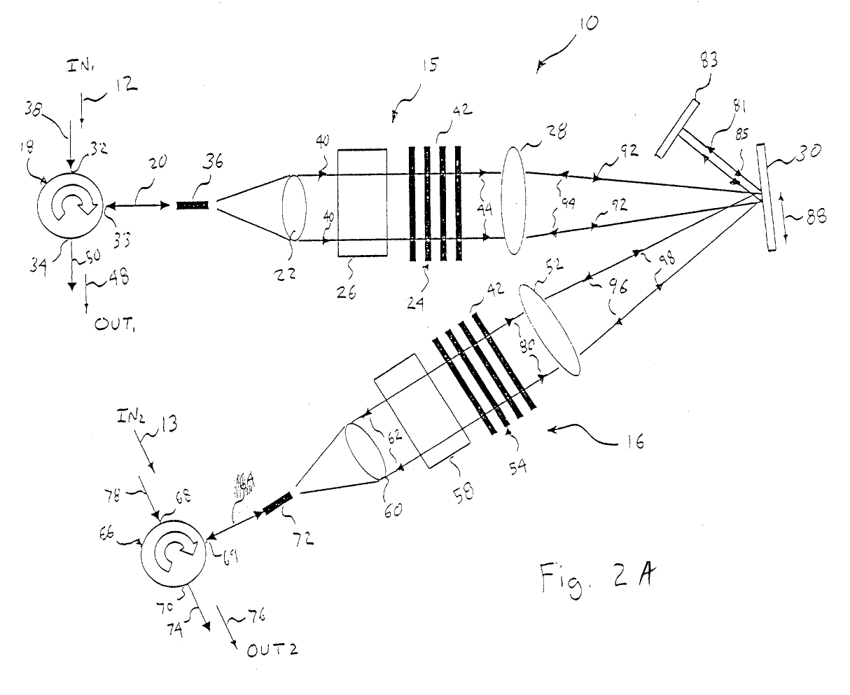

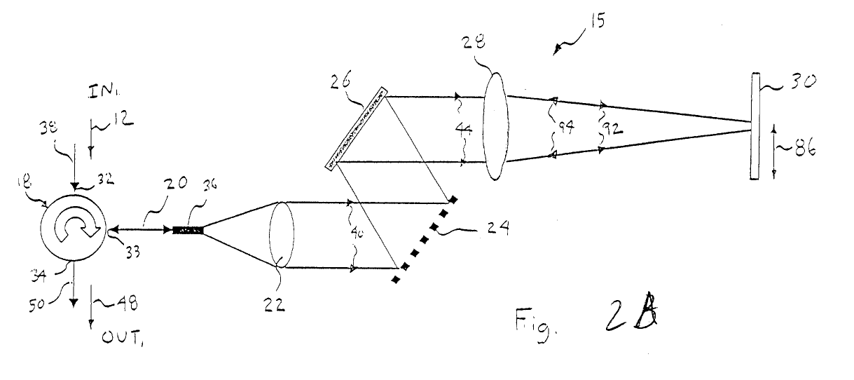

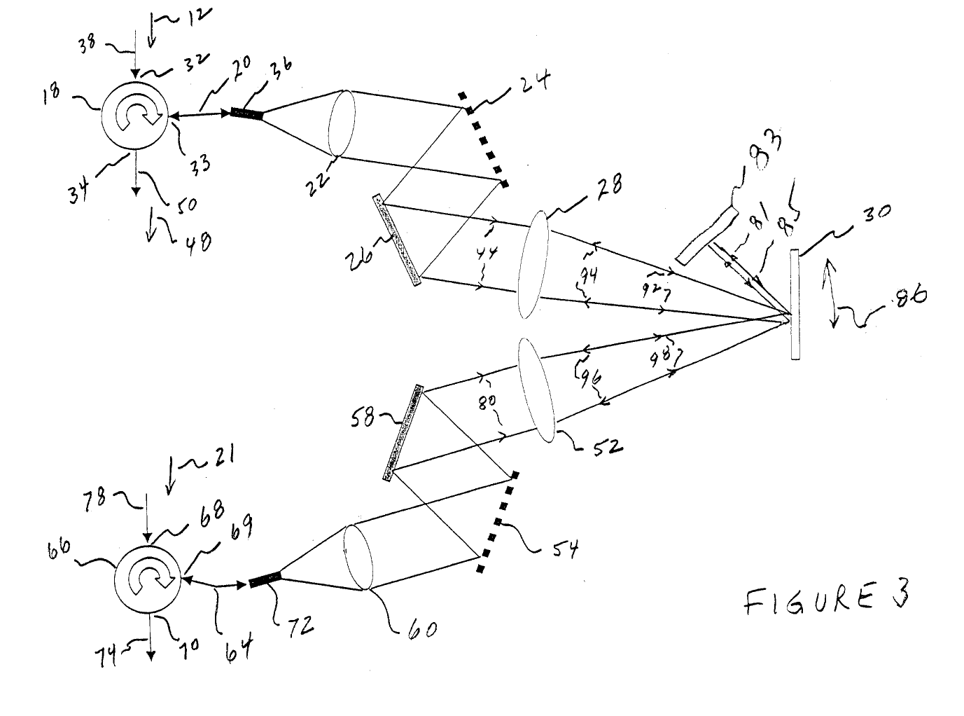

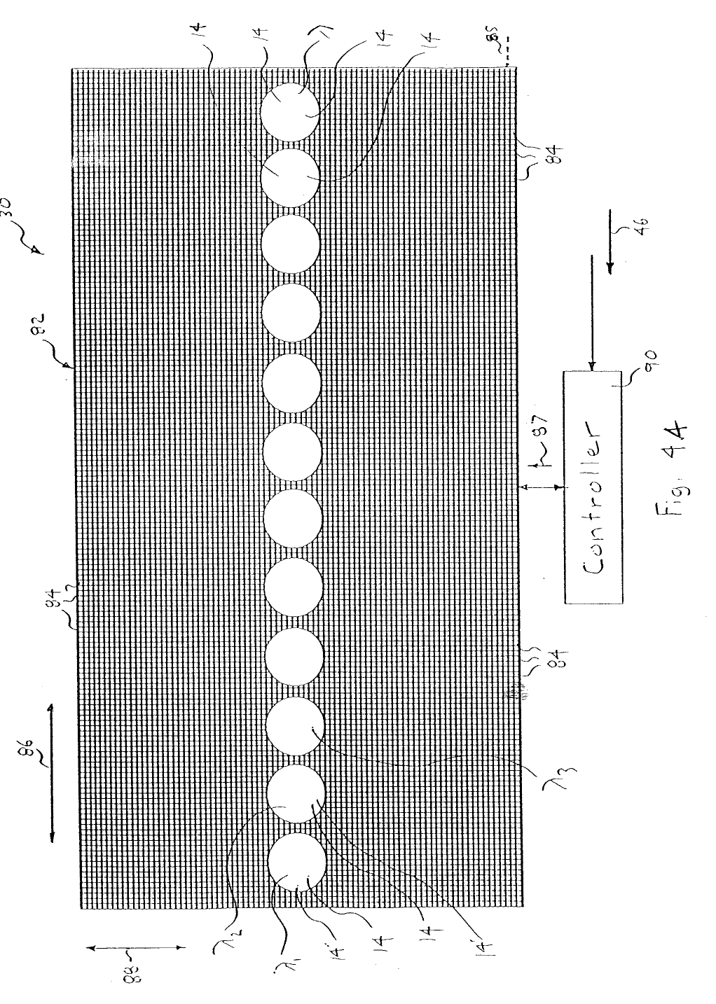

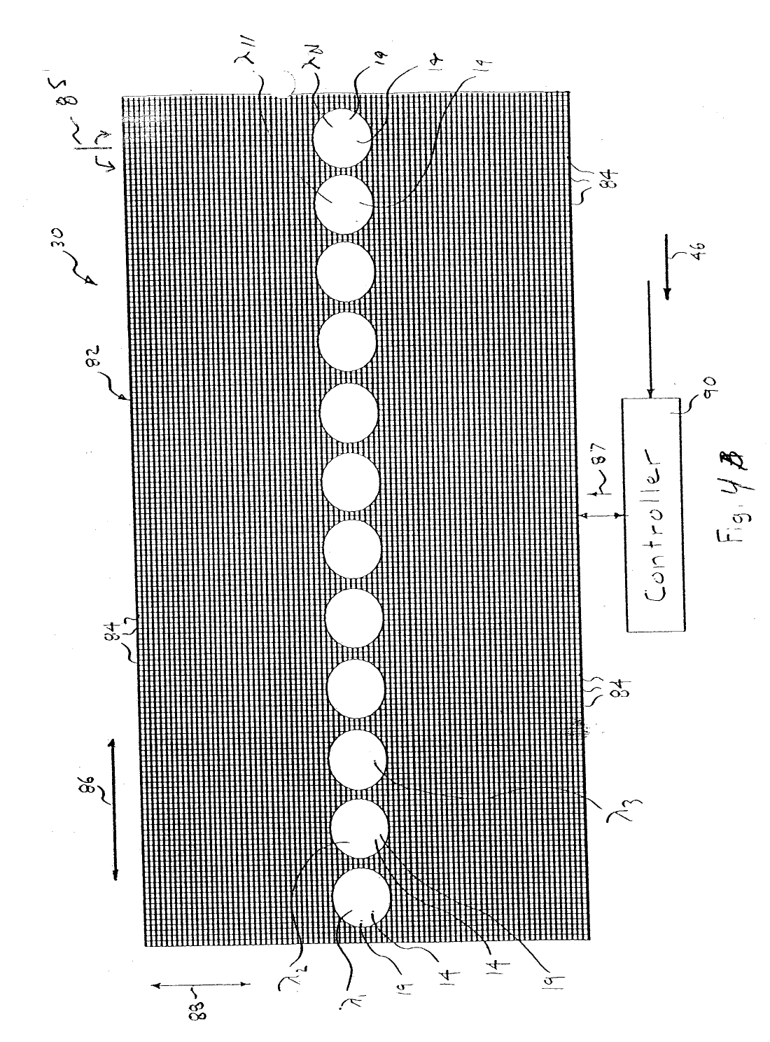

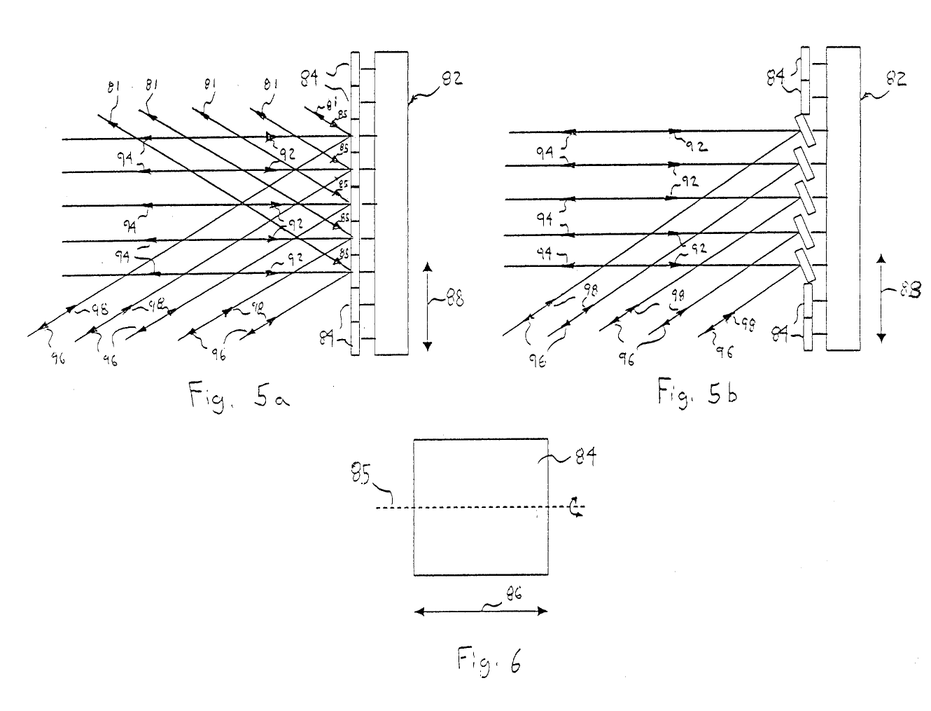

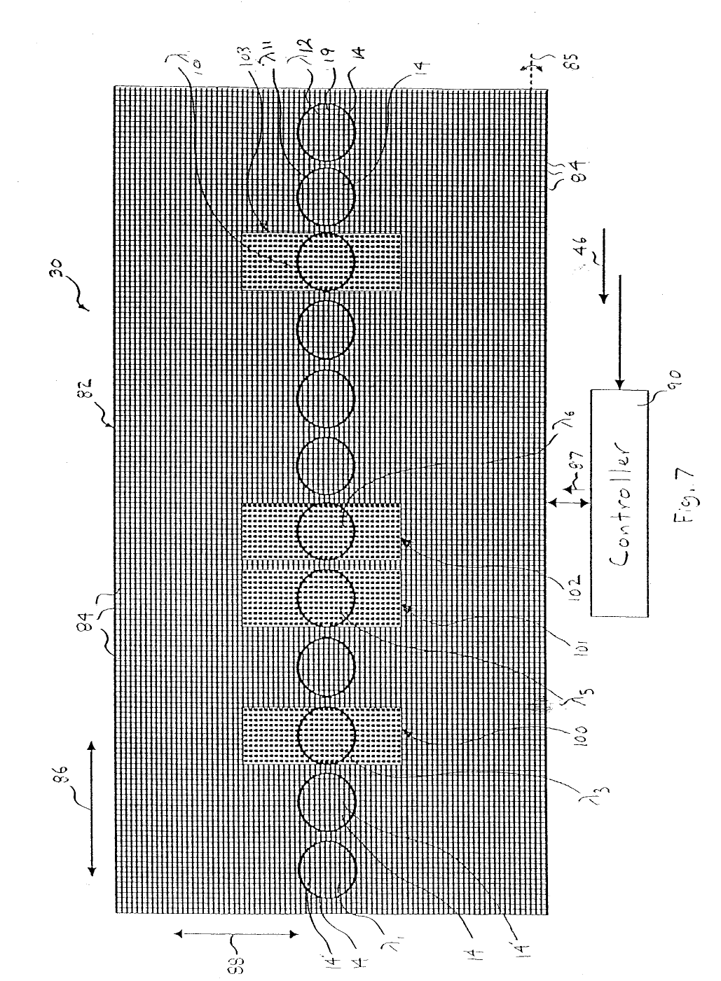

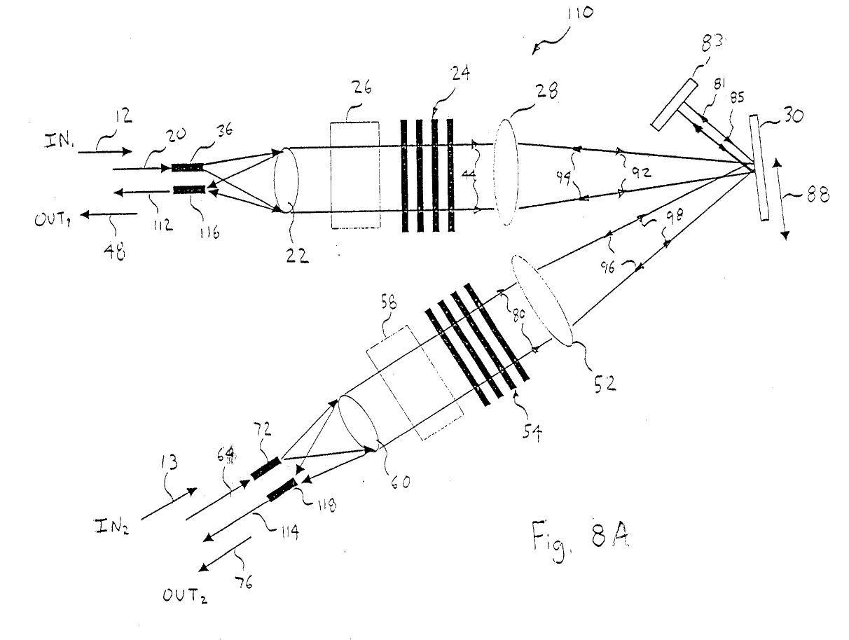

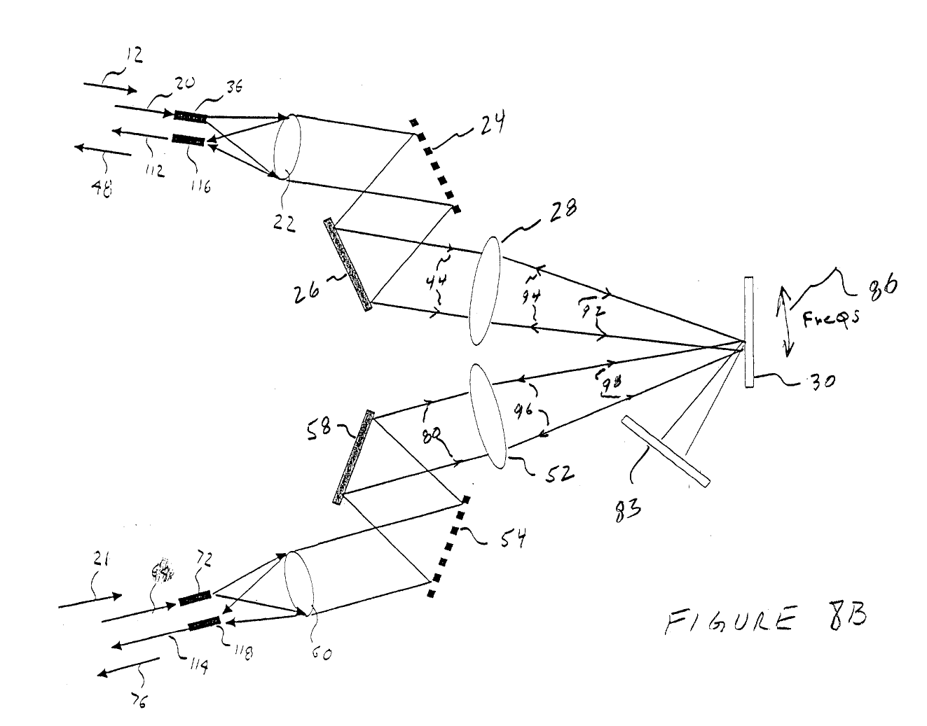

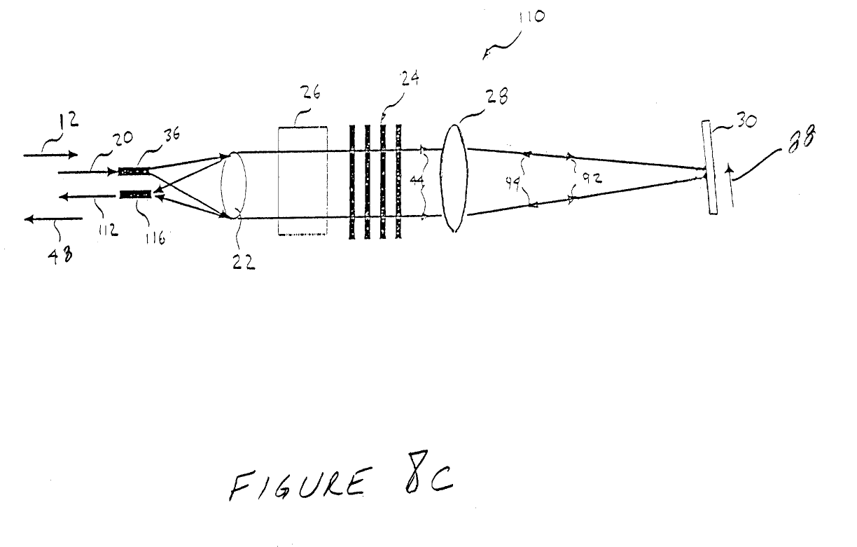

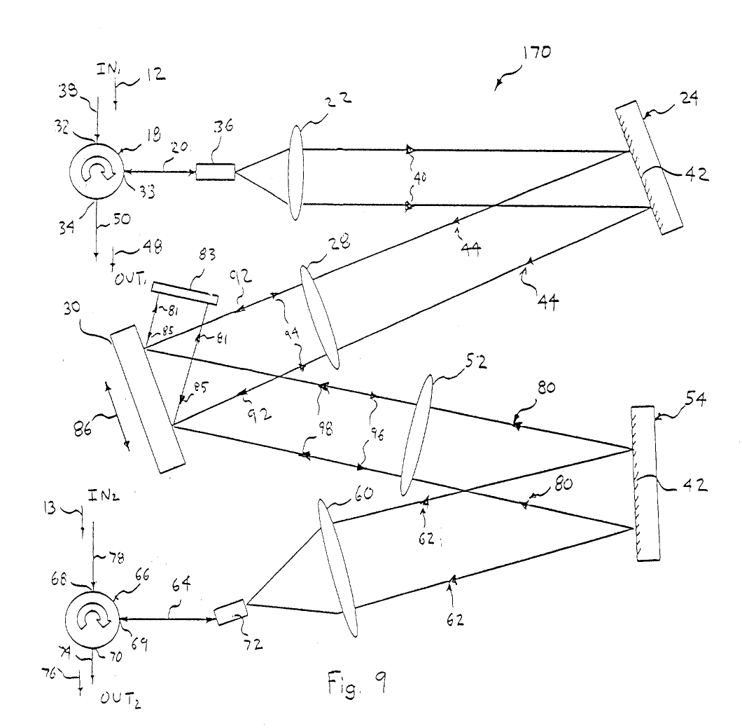

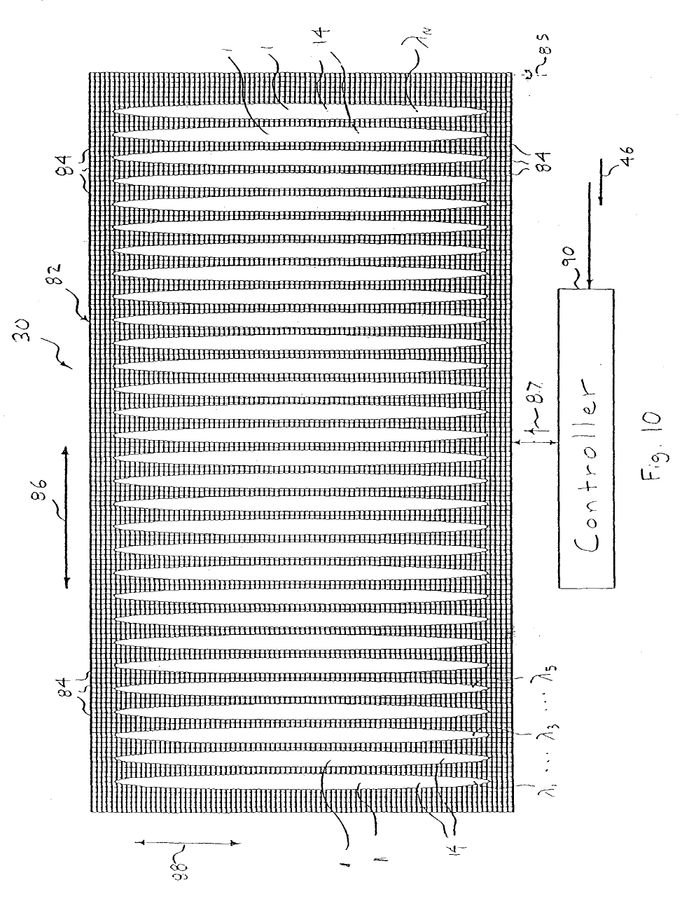

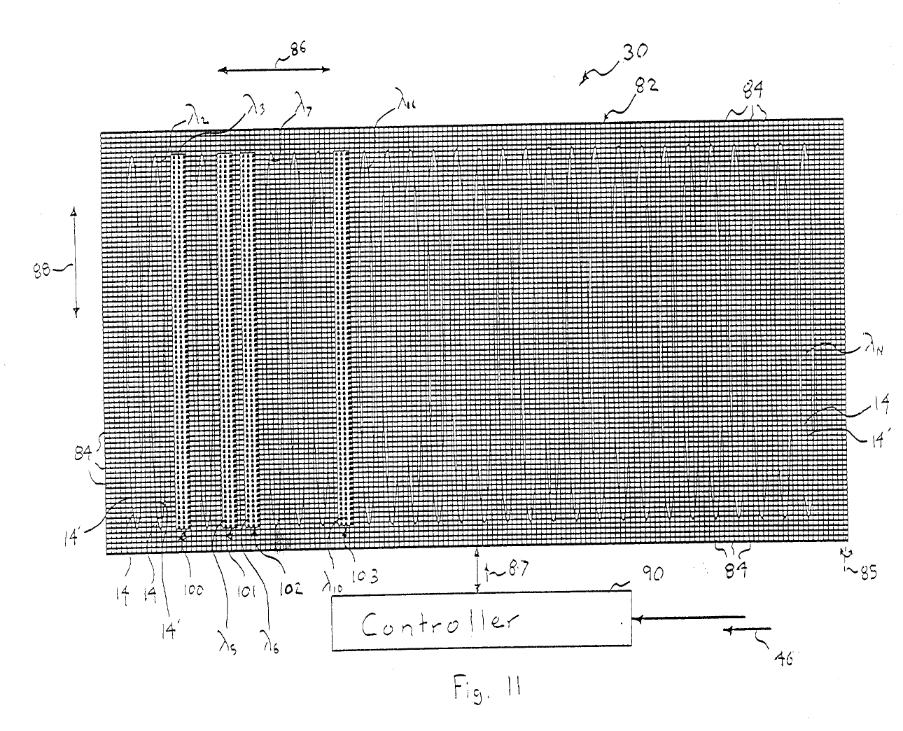

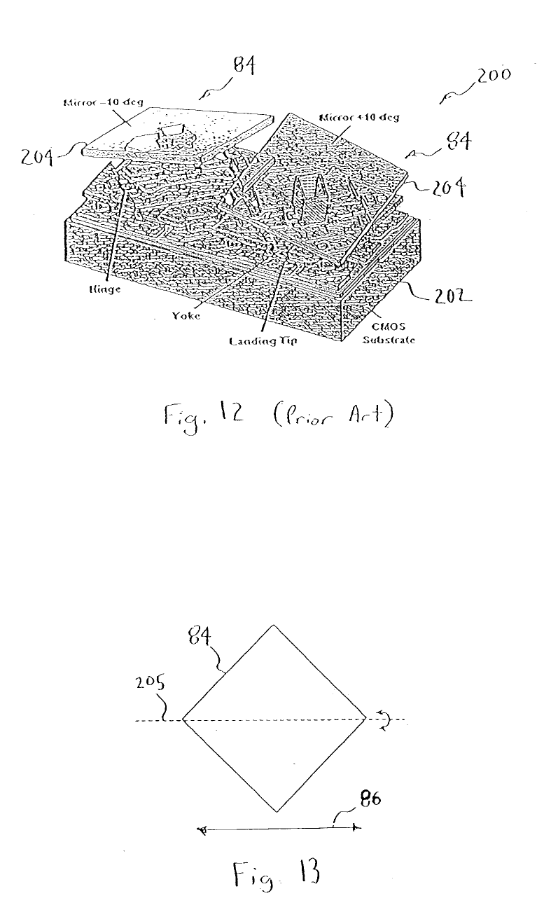

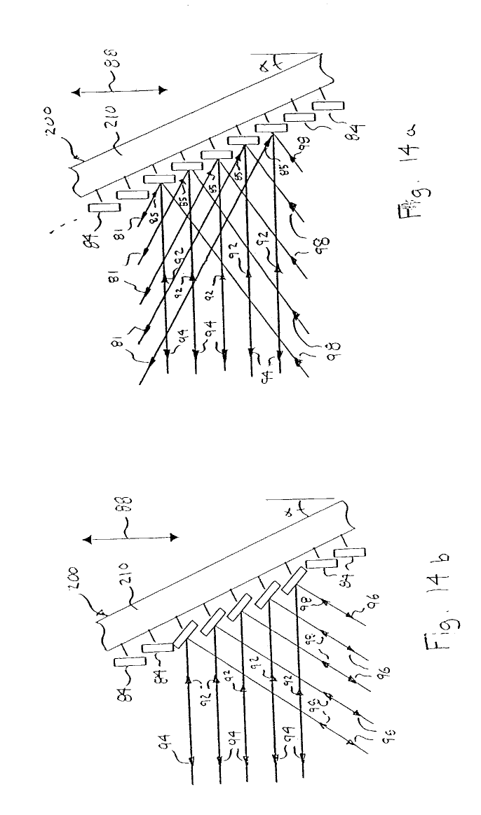

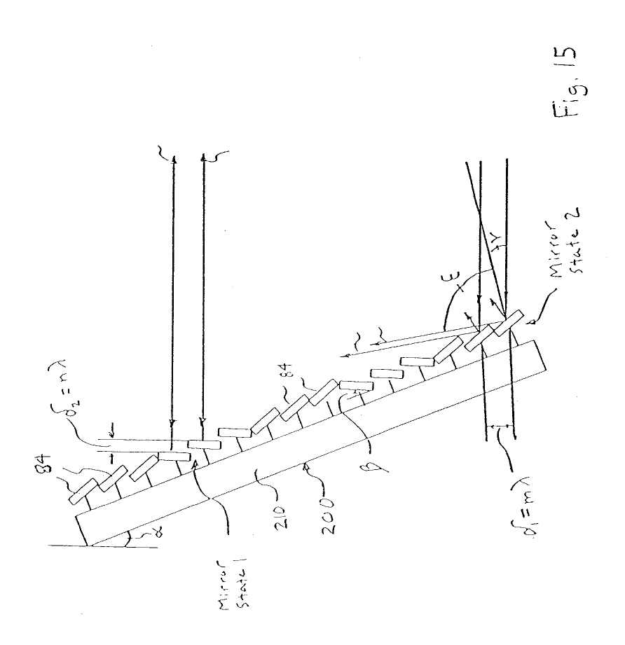

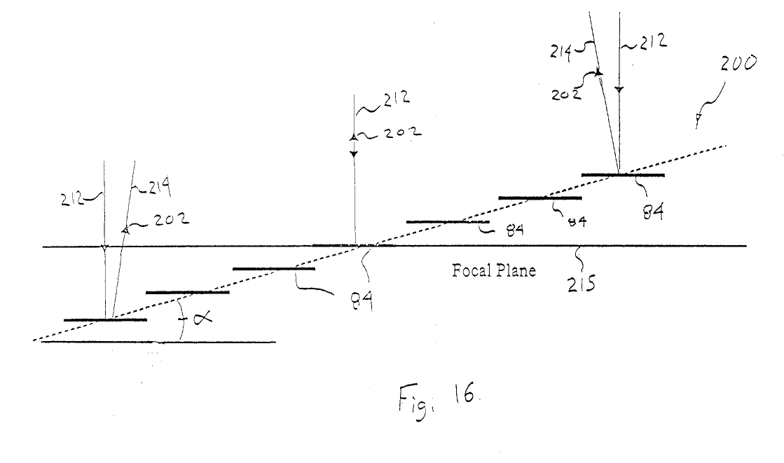

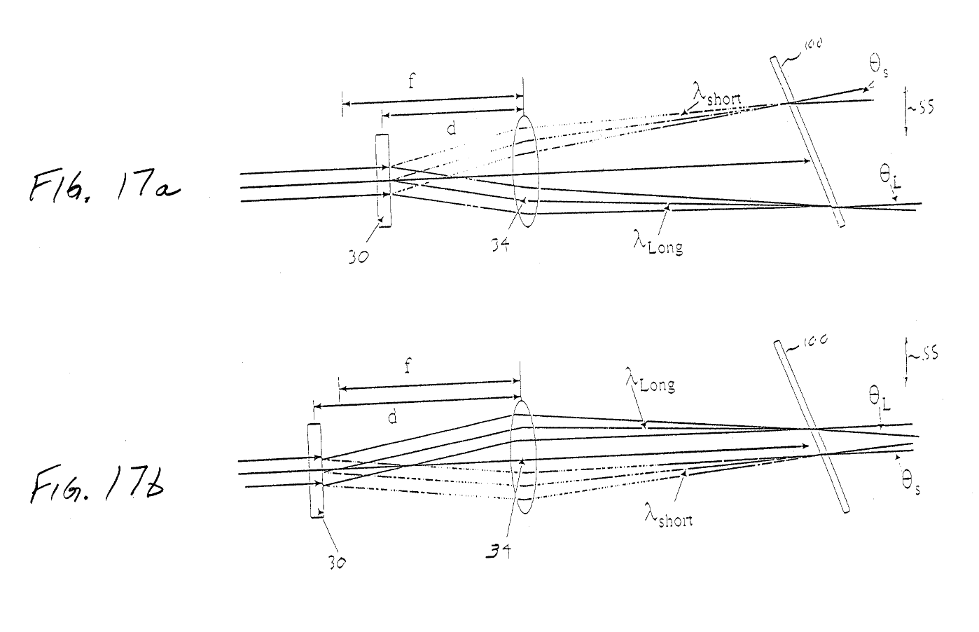

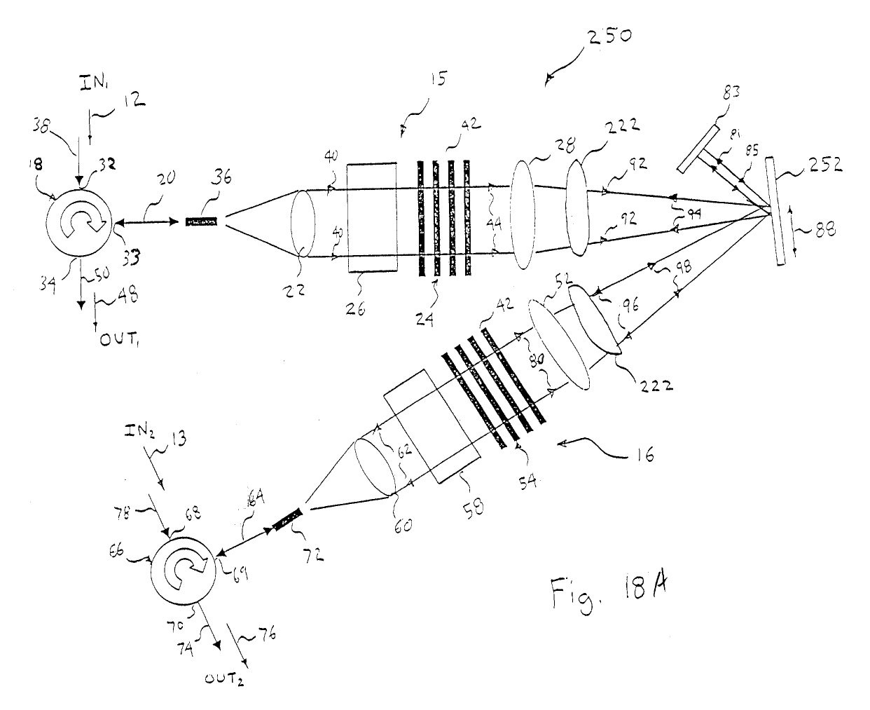

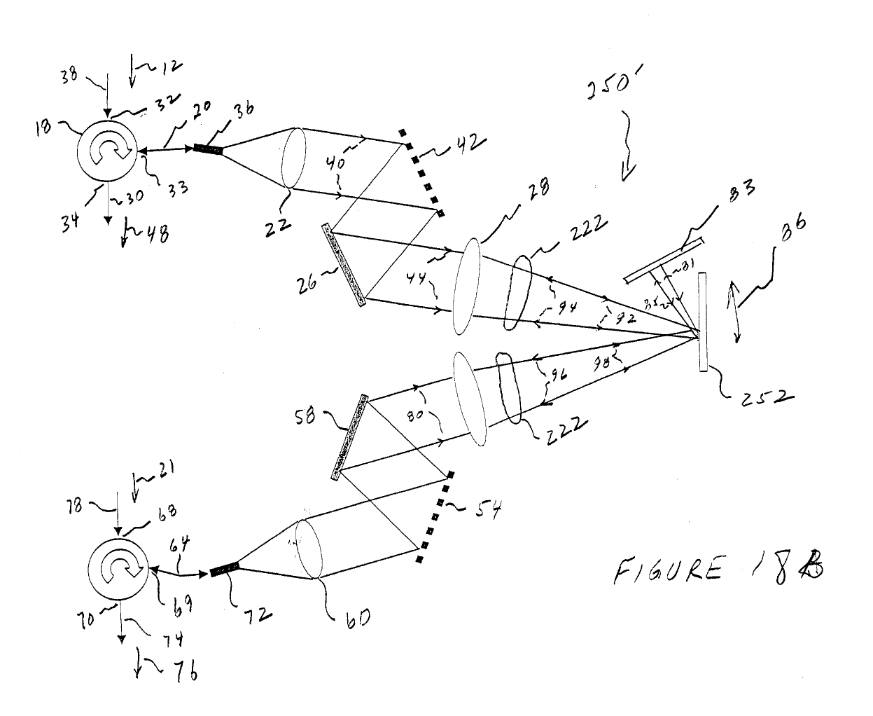

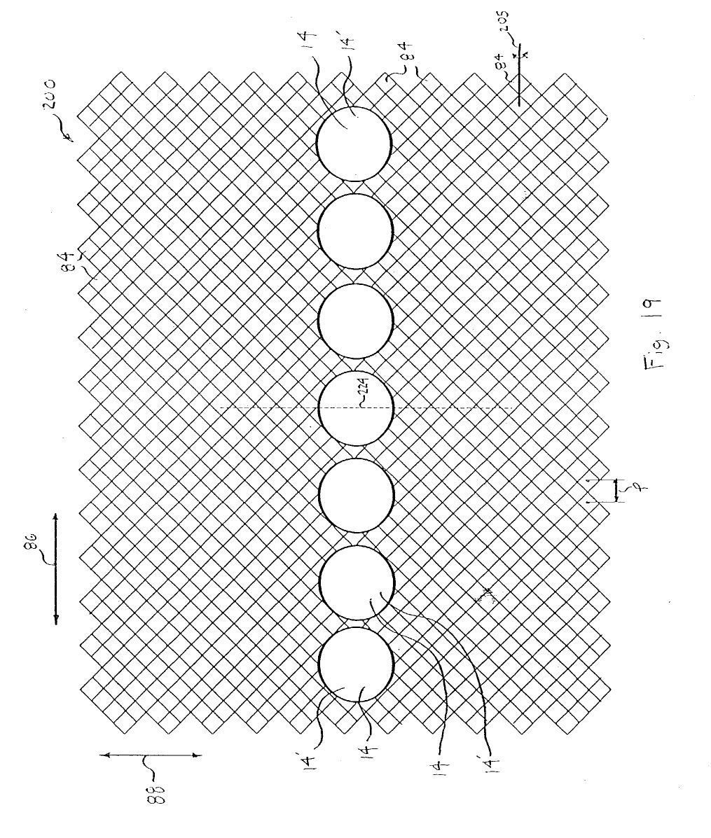

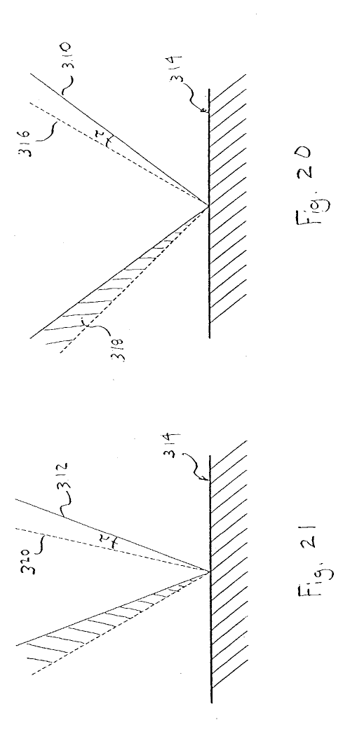

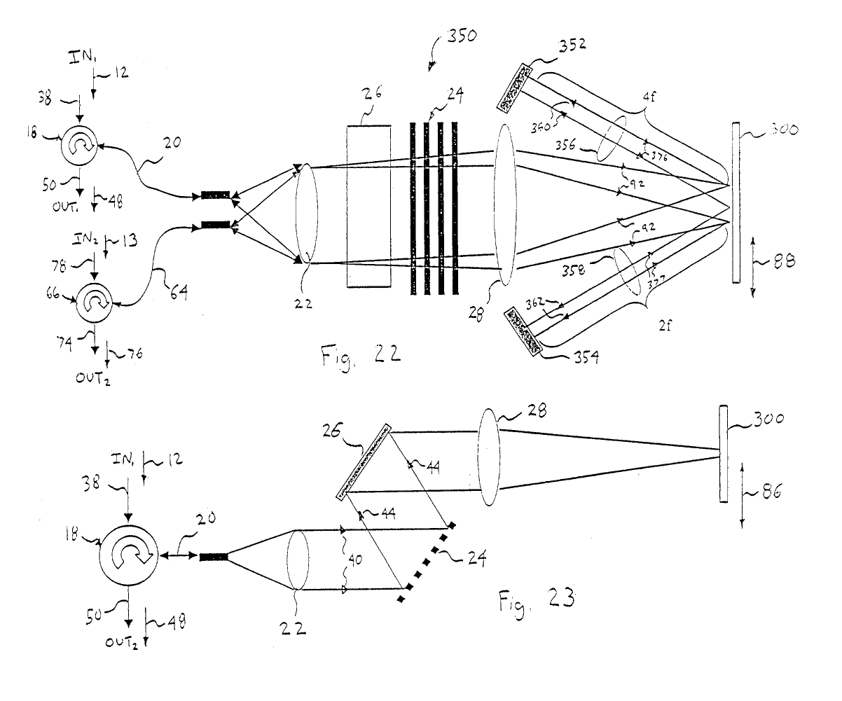

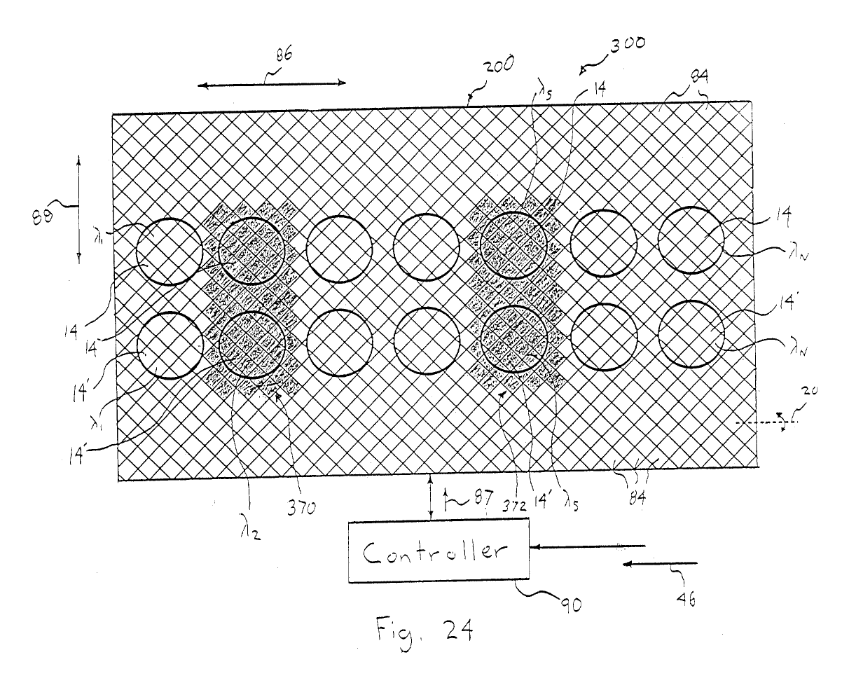

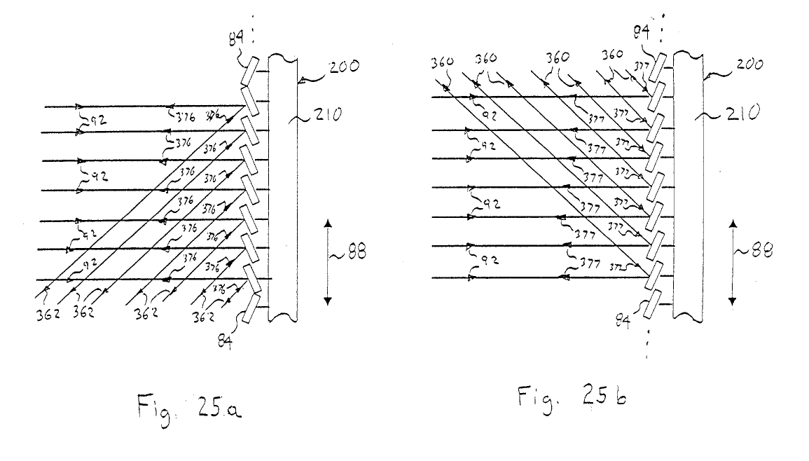

In FIGS. 2A and 2B, the optical cross-connect 10 comprises a pair of optical portions 15, 16 wherein one portion receives the first input signal 12 and the other portion 16 receives the second input signal 13. FIG. 2A is a plan view of the cross-connect 10 in the horizontal plane. Each optical portion 15, 16 includes substantially the same components disposed in substantially the same configuration. To better understand the cross-connect 10 of FIG. 2A, a side elevational view of one of the optical portions 15 is illustrated in FIG. 2A and will be described with the understanding that the other complementary optical portion 16 functions in a similar manner.

As shown in FIG. 2A, the optics of the optical portion 15 is disposed in two tiers or horizontal planes. Specifically, the optical portion 15 includes a three port circulator 18, an optical fiber or pigtail 20, a collimator 22, a light dispersive element 24, a mirror 26, and a bulk lens 28 for directing light to and from a spatial light modulator 30. As shown, the pigtail 20, the collimator 22 and the light dispersive element 24 are disposed in a first tier or plane parallel to the horizontal plane. The mirror 26, bulk lens 28 and the spatial light modulator 30 are disposed in the second tier also parallel to the horizontal plane.

The first three-port circulator 18 directs light from a first port 32 to a second port 33 and from the second port to a third port 34. The first optical fiber or pigtail 20 is optically connected to the second port of the circulator 18. A capillary tube 36, which may be formed of glass, is attached to one end of the first pigtail 20 such as by epoxying or collapsing the tube onto the first pigtail. The circulator 18 at the first port 32 receives the first WDM input signal 12 from an optical network (not shown) via optical fiber 38, and directs the input light to the first pigtail 20. The first input signal 12 exits the first pigtail (into free space) and passes through the first collimator 22, which collimates the input signal. The collimator 22 may be an aspherical lens, an achromatic lens, a doublet, a GRIN lens, a laser diode doublet or similar collimating lens. The collimated input signal 40 is incident on the first light dispersion element 24 (e.g., a diffraction grating or a prism), which separates spatially the optical channels of the collimated input signal 40 by diffracting or dispersing the light from (or through) the first light dispersion element.

In one embodiment, the first diffraction grating 24 is comprised of a blank of polished fused silica or glass with a reflective coating (such as evaporated gold or aluminum), wherein a plurality of grooves 42 (or lines) are etched, ruled or otherwise formed in the coating. The first diffractive grating 24 has a predetermined number of lines, such as 600 lines/mm, 850 lines/mm and 1200 lines/mm. The resolution of the cross-connect improves as the number of lines/mm in the grating increases. The grating 24 may be similar to those manufactured by Thermo RGL, part number 3325FS-660 and by Optometrics, part number 3-9601. Alternatively, the first diffraction grating may be formed using holographic techniques, as is well known in the art. Further, the first light dispersion element may include a prism or optical splitter to disperse the light as the light passes therethrough, or a prism having a reflective surface or coating on its backside to reflect the dispersed light.

As best shown in FIG. 2A, the diffraction grating 24 directs the separated light 44 to the first mirror 26 disposed in the second tier. The first mirror 26 reflects the separated light 44 to the first bulk lens 28 (e.g., a Fourier lens), which focuses the separated light onto the spatial light modulator 30, as shown in FIG. 4A. In response to a switching algorithm and input command 46, the spatial light modulator 30 reflects selected optical input channel(s) away from the first bulk lens 28 (i.e., the switched channels) to the other optical portion 16 and reflects the remaining optical input channel(s) (i.e., returned optical channel(s)) back through the same optical path to the first pigtail 20, as best shown in FIG. 2. The returned optical input channel(s) propagates from the second port 33 to the third port 34 of the optical circulator 18 to provide a first output signal 48 from optical fiber 50.

The switched channel(s) passes through the other optical portion 16 of the cross-connect 10. Specifically, the switched channel(s) passes through a second bulk lens 52 (e.g., a Fourier lens), and then reflects off a second mirror 58 onto a second light dispersion element 54, which is similar to the first light dispersion element 24. The second diffraction grating 54 further converges the switched channel(s). A second collimator 60, which is similar to collimator 28, focuses the dispersed light 62 onto a second pigtail 64, which is optically connected to a second 3-port circulator 66. The second circulator 66 directs light from a first port 68 to a second port 69 and from the second port to a third port 70. A capillary tube 72, which may be formed of glass, is attached to one end of the second pigtail 64 such as by epoxying or collapsing the tube onto the second pigtail. The switched channel(s) propagates from the second pigtail 64 to the output optical fiber 74, which is optically connected to the third port 70 of the second circulator 66, to provide a second output signal 76.

One or more optical channels 14′ of the second optical WDM input signal 13 may be switched to the first output signal 48. The second input channel(s) 14′ propagates from the optical fiber 78 to the second pigtail 64 through the second circulator 66.

The second input channel(s) 14′ exits the pigtail 64 and passes through the second collimator 60 to the second diffraction grating 54, which separates spectrally the second input channels of the collimated input signals 13 by dispersing or diffracting from (or through) the second diffraction grating 54. The diffraction grating 54 directs the separated light 80 to the second mirror 58 disposed in the second tier, similar to that described above in FIG. 3 for the optical portion 15. The mirror 58 reflects the separated light 80 to the second bulk lens 52, which focuses the separated light 80 onto the spatial light modulator 30. The spatial light modulator 30 reflects the complementary switched channel(s) 14′ of the separated light 80 to the first bulk lens 28 and reflects the remaining second input channel(s) away from the spatial light modulator 30, as shown by arrows 81, to a mirror 83. The remaining second input channel(s) 14′ (i.e., returned optical channel(s)) reflect back off the mirror 83 and through the second optical portion 16 to the second pigtail 64, as best shown in FIG. 2. The returned optical input channel(s) 14′ propagates from the second port 69 to the third port 70 of the second optical circulator 66 to provide a second output signal 76 from optical fiber 74.

The complementary switched channel(s) 14′ passes through the first bulk lens 28, which are then reflected off the first mirror 26 onto the first diffraction grating 24. The first diffraction grating further converges the complementary switched channel(s) 14′ onto the first collimator 22 which focuses the complementary switched channels to the first pigtail 22. The complementary switched channel(s) propagates from the first pigtail 20 to optical fiber 50, to thereby switch the complementary switched channel(s) to the first output signal 48. As will be described hereinafter, the second input channels 14′ and first input channels 14 at the same wavelengths reflect off the same portion of spatial light modulator 20, and therefore when a first input channel 14 of the first input signal 12 is switched to the second output signal 76, the complementary input channel 14′ of the second input signal 13 is switched simultaneously.

As shown in FIG. 4A, the spatial light modulator 30 comprises a micro-mirror device 82 having a two-dimensional array of micro-mirrors 84, which cover a surface of the micro-mirror device. The micro-mirrors 84 are generally square and typically 14-20 microns (μm) wide with 1 μm spaces between them. FIG. 5a illustrates a partial row of micro-mirrors 84 of the micro-mirror device 82, when the micro-mirrors are disposed in a first position to reflect the light back along the return path and provide the first input channel 14 back to the first output 50. FIG. 5b illustrates a partial row of micro-mirrors 84 when the micro-mirrors are disposed in a second position that reflect a selected first input channel 14 of the first input signal 12 to the second output 74 and reflect the complementary input signal 14′ of the second input signal 13 to the first output 48, as will be described in greater detail hereinafter. The micro-mirrors may operate in a “digital” fashion. In other words, as the micro-mirrors either lie flat in a first position, as shown in FIG. 5a, or be tilted, flipped or rotated to a second position, as shown in FIG. 5b.

As described herein before, the positions of the micro-mirrors 84, either flat or tilted, are described relative to the optical path wherein “flat” refers to the mirror surface positioned orthogonal to the light path, either coplanar in the first position or parallel as will be more fully described hereinafter. The micro-mirrors 84 flip about an axis 85 parallel to the spectral axis 86, as shown in FIG. 6, wherein the spectral axis is defined by the direction the channels (λₙ) of the optical input signal 12 is spread by the diffraction grating 24. One will appreciate, however, that the micro-mirrors may flip about any axis, such as parallel to the spatial axis 88, at a 45 degrees angle to the spatial axis, or any desired angle.

In FIG. 4A, the micro-mirrors 84 are individually flipped between the first position and the second position in response to a control signal 87 provided by a controller 90 in accordance with a switching algorithm and an input command 46. The switching algorithm may provide a bit (or pixel) map indicative of the state (flat or tilted) of each of the micro-mirrors 84 of the array to switch the desired optical input channel(s) 14 between the outputs 48, 76 (see FIG. 2), and thus requiring a bit map for each configuration of channels to be dropped and added. Alternatively, each group of micro-mirrors 84, which reflect corresponding optical channels 14, 14′, may be individually controlled by flipping the group of micro-mirrors 84 to direct the channels along a desired optical path (i.e., return or switched paths).

One will appreciate that the cross-connect 10 may be selctively configured or modified for any wavelength plan by simply modifying the software. For example, a cross-connect for filtering a 50 GHz WDM optical signal may be modified to filter a 100 GHz or 25 GHz WDM optical signal by simply modifying or downloading a different switching algorithm, without modifying the hardware. In other words, any changes to the WDM signal structure (such as varying the spacing of the channels, the shapes of the light beams, and center wavelength of the light beams) may be accommodated within the cross-connect by simply modifying statically or dynamically the switching algorithm (e.g., modifying the bit map).

As shown in FIGS. 2A and 5a, the micro-mirror device 82 is oriented to reflect the focused light 92 of the first input signal 12 back through the first bulk lens 28 to the first pigtail 20, as indicated by arrows 94, to the first output signal 48, and to reflect the focused light 98 of the second input signal 13 off the mirror 83, as indicated by arrows 81, and back (see arrows 85) to the second output 76, when the micro-mirrors 84 are disposed in the first position. As shown in FIGS. 2A and 5b, the focused light 92 of the first input signal 12 reflects away from the first bulk lens 28 to the second output 74, as indicated by arrows 96, and the focused light 98 of second input signal 13 reflects away from the second bulk lens 52 to the first output 50, when the micro-mirrors 84 are disposed in the second position. This “digital” mode of operation of the micro-mirrors advantageously eliminates the need for any type of feedback control for each of the micro-mirrors. The micro-mirrors 84 are either “on” or “off” (i.e., first position or second position), respectively, and therefore, can be controlled by simple binary digital logic circuits.

FIG. 4A further illustrates the outline of the optical input channels 14, 14′ of the first and second input signals 12, 13, which are dispersed off respective diffraction gratings 24, 54 and focused by bulk lens 28, 52 respectively, onto the array of micro-mirrors 84 of the micro-mirror device 82. The input channels 14, 14′ at each corresponding wavelength illuminate the same area of the micro-mirror device 82 as shown. Each optical channel 14, 14′ is distinctly separated from other channels across the spectrum and have a generally circular cross-section, such that the optical channels do not substantially overlap spatially when focused onto the spatial light modulator 30. The input channels 14, 14′ have a circular cross-section to project as much of the beam as possible over a multitude of micro-mirrors 84, while keeping the optical channels separated by a predetermined spacing. One will appreciate though that the diffraction gratings 24, 54 and bulk lens 28, 52 may be designed to reflect and focus any input channel or group of input channels with any desired cross-sectional geometry, such as elliptical, rectangular, square, polygonal, etc. Regardless of the cross-sectional geometry selected, the cross-sectional area of the channels 14 should illuminate a plurality of micro-mirrors 84, which effectively pixelates the optical channels. In an exemplary embodiment, the cross sectional area of the input channels 14, 14′ is generally circular in shape, whereby the width of the optical channel beam spans over approximately 11 micromirrors.

One will appreciate that while the spacing between each spectrum of input channels 14, 14′ are predetermined, the spacing between may be non-uniform. For example, one grouping of channels 14, 14′ may be spaced to correspond to a 100 GHz spacing, and another group of channels 14, 14′ may be spaced to correspond to a 50 GHz spacing.

FIG. 7 is illustrative of the position of the micro-mirrors 84 of the micro-mirror device 82 for switching adding the optical channels 14, 14′ at λ₃, λ₅, λ₆, λ₁₀, for example. The outline of each channel 14, 14′ is shown to provide a reference to visually locate the groups of tilted mirrors 100-103. As shown, the groups of mirrors 100-103 associated with each respective optical channel at λ₃, λ₅, λ₆, λ₁₀, are tilted away from the return path to the second position, as indicated by the blackening of the micro-mirrors 84. Each group of tilted mirrors 100-103 provides a generally rectangular shape, but one will appreciate that any pattern or shape may be tilted to redirect an optical channel. In an exemplary embodiment, the groups of micro-mirrors 100-103 reflect substantially all the light of each respective input channel 14, 14′ and do reflect substantially no light of any adjacent channels. The micro-mirrors 84 of the other input channels 14, 14′ at wavelengths of λ₁, λ₂, λ₄, λ₇, λ₈, λ₉, λ₁₁-λ_{N} are flat (i.e., first position), as indicated by the white micro-mirrors, to reflect the light 92 back along the return path to the first pigtail 20, as described hereinbefore.

As described hereinbefore, the input channel 14 of the first input signal 12 and the complementary input channel 14′ of the second input signal 13, which are centered at the same wavelength, are focused onto the same group of micro-mirrors. For example, both the first input channel 14 at λ₃ and complementary input channel 14′ at λ₃ reflect off the same group of mirrors 100. Consequently, when the micro-mirrors are disposed in the tilted (or second position), the first input channel 14 is switched with the complementary input channel 14′ at the output 50, 74.

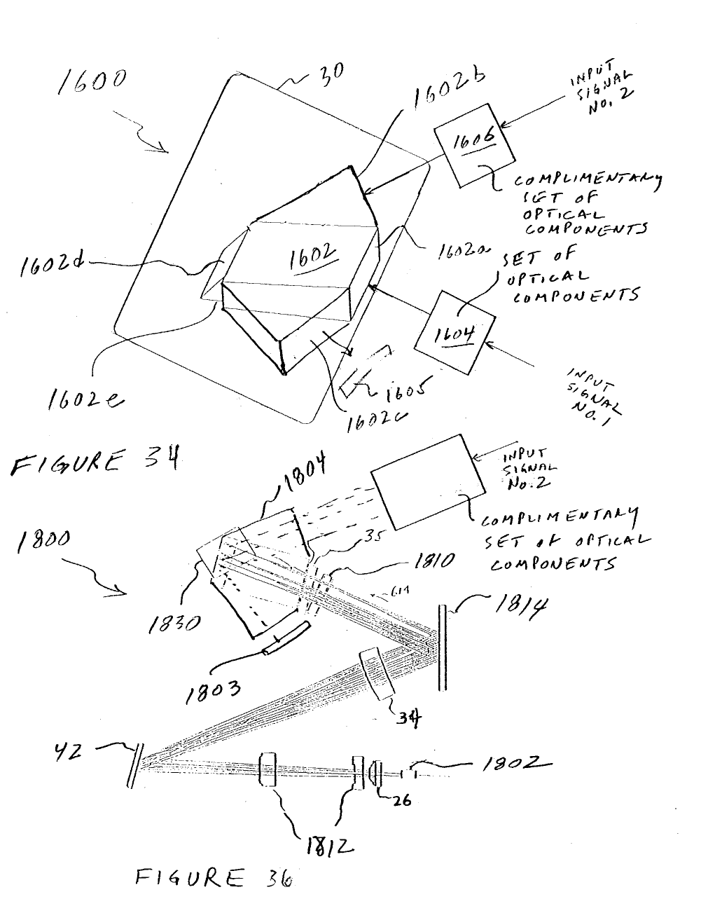

FIG. 3 shows an alternative embodiment to that shown in FIGS. 2A and 2B, wherein the DMD device 30 is oriented so that the mirrors 84 pivot or tilt on a spatial axis 85′ that is perpendicular to the spectral axis 86 as best shown in FIG. 4B. (As shown, the spatial axis 85′ runs into and out of FIG. 4B.) This embodiment is particularly important when implementing the chisel prism arrangement discussed below in relation to FIGS. 34-36. Similar elements in FIGS. 2A, 2B and 3 are labelled with similar reference numerals.

### FIGS. 8A-8C: Cross-Connect 110

FIG. 8A shows another exemplary embodiment of a cross-connect generally indicated as 110 that is substantially similar to the cross-connect 10 of FIG. 2A, and therefore, common components have the same reference numeral. The cross-connect 110 replaces the circulators 18, 66 of FIG. 2A with a pair of pigtails 112, 114. Each pigtail 112, 114 has a glass capillary tube 116, 118, respectively is attached to one end of the pigtails. Each of the pigtails 112, 114 receives the optical channels reflected from the micro-mirror device back along a respective optical path. Specifically, pigtail 112 receives the returned first input channels 14 and switched second input signals 14′, and pigtail 114 receives the returned second input channels 14′ and the switched first input channels 14.

To accomplish these expected return paths, the spatial light modulator 30 cannot be an image plane of the first pigtail 20 along the spatial axis 88. These conditions can be established by ensuring that the lens system 22 and 28 be astigmatic. In particular, the lens 28 may be a cylindricalized lens with its cylindrical axis parallel to the spatial axis 88. By tilting the spatial light modulator 30, the return path 94 can be displaced to focus at pigtail 112 and the return path 96 can be displaced to focus at pigtail 114.

FIGS. 8B and 8C show alternative embodiments to the cross-connet shown in FIG. 8A, wherein the DMD device 30 is oriented so that the mirrors 84 tilt on the spatial axis 85′ that is perpendicular to the spectral axis 86 as best shown in FIG. 4A. (As shown, the spatial axis 85′ runs into and out of the FIGS. 8B and 8C. These embodiments are particularly important when implementing the chisel prism arrangement discussed below in relation to FIGS. 34-36. Similar elements in FIGS. 8A, 8B and 8C are labelled with similar reference numerals.

### FIGS. 9-16: Cross-Connect 170

FIG. 9 shows another embodiment of a cross-connect 170 in accordance with the present invention, which is similar to the cross-connect 10 of FIG. 2A, and therefore similar components have the same reference numerals. The cross-connect 170 is substantially the same as the cross-connect depicted in FIG. 2A, except the optical components of the cross-connect 170 are disposed in one horizontal plane, rather than two tiers or planes, as shown in FIG. 3. Rather than using a mirror 26, 58 (in FIGS. 2A and 3) to direct the dispersed light 44, 80 to the bulk lens 28, 52 and the spatial light modulator 30, the diffraction grating is tilted and rotated 90 degrees to directly disperse the light onto the bulk lens which focuses the light onto the spatial light modulator.

Functionally, the cross-connect 170 of FIG. 9 and cross-connect 10 of FIG. 2A are substantially the same. For illustrative purposes however, the diffraction gratings 24, 54 and the bulk lens 28, 52 of the cross-connect 170 are different to provide dispersed input channels 14, 14′ incident on the micro-mirror device 82 having a substantially elliptical cross-section, as shown in FIG. 10. As described, the diffraction gratings are rotated approximately 90 degrees such that the spectral axis 86 of the input channels 14, 14′ is parallel to the horizontal plane, and the micro-mirror device 82 is similarly rotated approximately 90 degrees such that the spectral axis 86 of the input channels 14, 14′ is perpendicular to the tilt axis 85 of the micro-mirrors 84.

FIG. 11 is illustrative of the position of the micro-mirrors 84 of the micro-mirror device 82 for switching the optical channels 14, 14′ at λ₃, λ₅, λ₆, λ₁₀, for example, between the input signals 12, 13. The outline of each input channel 14, 14′ is shown to provide a reference to visually locate the groups of tilted mirrors 100-103. As shown, the group of mirrors 100-103 associated with each respective optical channel at λ₃, λ₅, λ₆, λ₁₀, are tilted away from the return path to the second position, as indicated by the blackening of the micro-mirrors 84. Each group of tilted mirrors 100-103 provides a generally rectangular shape. In an exemplary embodiment, the group of micro-mirrors 100-103 reflects substantially all the light of each respective input channel 14, 14′ and does not reflect the light of any adjacent channels. The micro-mirrors 84 of the other optical input channels 14, 14′ at wavelengths of λ₁, λ₂, λ₄, λ₇, λ₈, λ₉, λ₁₁-λ_{N} are flat (i.e., first position), as indicated by the white micro-mirrors, to reflect the light back along the return path to the first pigtail 22, as described hereinbefore.

The micro-mirror device 82 of FIGS. 2A-4 is similar to the Digital Micromirror Device™ (DMD™) manufactured by Texas Instruments and described in the white paper entitled “Digital Light Processing™ for High-Brightness, High-Resolution Applications”, white paper entitled “Lifetime Estimates and Unique Failure Mechanisms of the Digital Micromirror Device (DMD)”, and news release dated September 1994 entitled “Digital Micromirror Display Delivering On Promises of ‘Brighter’ Future for Imaging Applications”, which are incorporated herein by reference.

### FIGS. 12-13: Micro-Mirror Device 200

FIG. 12 illustrates a pair of micro-mirrors 84 of a micromirror device 200 manufactured by Texas Instruments, namely a digital micromirror device (DMD™). The micromirror device 200 is monolithically fabricated by CMOS-like processes over a CMOS memory 202. Each micro-mirror 84 includes an aluminum mirror 204, 16 μm square, that can reflect light in one of two directions, depending on the state of the underlying memory cell 202. Rotation, flipping or tilting of the mirror 204 is accomplished through electrostatic attraction produced by voltage differences between the mirror and the underlying memory cell. With the memory cell 202 in the on (1) state, the mirror 204 rotates or tilts approximately+10 degrees. With the memory cell in the off (0) state, the mirror tilts approximately−10 degrees. As shown in FIG. 13, the micro-mirrors 84 flip about an axis 205.

FIGS. 14a and 14b illustrate the orientation of a micro-mirror device 200 similar to that shown in FIG. 13, wherein neither the first or second position (i.e., on or off state) of the micro-mirrors 84 is parallel to the base or substrate 210 of the micro-mirror device 200, as shown in FIGS. 5a and 5b. Consequently as shown in FIG. 14a, the base 210 of the micro-mirror device 200 is mounted at a non-orthogonal angle á relative to the collimated light 83 to position the micro-mirrors 84, which are disposed at the first position, perpendicular to the collimated light 44, so that the focused light 92 of the first input signal 12 reflects back through the return path, as indicated by arrows 94, to provide the first output signal 48 at optical fiber 50, and the focused light 98 of the second input signal 13 reflects off the mirror 83 and back along the second return path, as indicated by arrows 81, 85, to provide the second output signal 76 at optical fiber 74, when the micro-mirrors 84 are disposed in the first position. Consequently, the tilt angle of the mirror between the horizontal position and the first position (e.g., 10 degrees) is approximately equal to the angle á of the micro-mirror device. As shown in FIGS. 2A and 14b, the focused light 92 of the first input signal 12 reflects away from the first bulk lens 28 to the second output 74, as indicated by arrows 96, and the focused light 98 of second input signal 13 reflects away from the second bulk lens 52 to the first output 50, when the micro-mirrors 84 are disposed in the second position.

### FIGS. 15-16: Phase Condition and Pixel Pitch

FIG. 15 illustrates the phase condition of the micro-mirrors in both states (i.e., State 1, State 2) for efficient reflection in either condition. In using the micro-mirror array device 200, it is important that the reflection from each micro-mirror 84 adds coherently in the far-field, so the angle α to which the micro-mirror device 200 is tilted has a very strong influence on the overall efficiency of the device.

In an exemplary embodiment of the micro-mirror device 200 in FIG. 15, the effective pixel pitch ñ is about 19.4 μm (see FIG. 19), so for a mirror tilt angle α of 9.2 degrees, the array is effectively blazed for Littrow operation in the n=+2 order for the position indicated as Mirror State 1 in FIG. 17 (i.e., first position). For Mirror State 2, the incident angle ã on the micro-mirror device 200 is now 9.2 degrees and the exit angle \dot{a} from the array is 27.6 degrees. Using these numbers, the micro-mirror device is nearly blazed for fourth-order for mirrors in Mirror State 2.

FIG. 16 graphically illustrates the micro-mirror device 200 wherein the micro-mirrors 84 are disposed in the retro-reflective operation (i.e., first position), such that the incident light reflects back along the return path, as indicated by arrows 202. For retro-reflective operation, the micro-mirror device 200 acts as a blazed grating held in a “Littrow” configuration, as shown in FIG. 2A, with the blaze angle equal to the mirror tilt “α” (e.g., 10 degrees). The grating equation provides a relationship between the light beam angle of incidence, θᵢ; angle of reflection, θₘ; the pitch of the micro-mirror array; the mirror tilt; and the wavelength of the incident light. Because the wavelength varies across the micro-mirror array for parallel input beams, the angle of reflection of the beams varies across the apparatus. Introducing the micro-mirror device 200 at the focal plane 215 implements the critical device feature of providing separately addressable groups of mirrors to reflect different wavelength components of the beam. Because of the above reflection characteristics of the micro-mirror device 200, the beam is reflected as from a curved concave mirror surface, as shown in FIG. 17 with the micro-mirror device 200 in the focal plane 215. Consequently, when the micro-mirror device is oriented to retro-reflect at a wavelength hitting near the mirror center, wavelengths disposed away from the center are reflected toward the beam center as if the beam were reflected from a curved concave mirror. In other words, the micro-mirror device 200 reflects the incident light 212 reflecting off the central portion of the array of micro-mirrors directly back along the incident angle of the light, while the incident light 212 reflecting off the micro-mirrors disposed further away from the central portion of the array progressively direct the light inward at increasing angles of reflection, as indicated by 214.

### FIGS. 17a, 17b

FIGS. 17a and 17b illustrate a technique to compensate for this diffraction effect introduced by the micromirror array, described hereinbefore.

FIG. 17a illustrates the case where a grating order causes the shorter wavelength light to hit a part of the micromirror array 100 that is closer than the section illuminated by the longer wavelengths. In this case the Fourier lens 34 is placed at a distance “d” from the grating 30 that is shorter than focal length “f” of the Fourier lens. For example, the distance “d” may be approximately 71 mm and the focal length may be approximately 82 mm. It may be advantageous to use this configuration if package size is limited, as this configuration minimizes the overall length of the optical train.

FIG. 17b illustrates the case where the grating order causes the longer wavelengths to hit a part of the micromirror array 100 that is closer than the section illuminated by the shorter wavelengths. In this case the Fourier lens is placed a distance “d” from the grating 30 that is longer than focal length “f” of the Fourier lens 34. This configuration may be advantageous to minimize the overall area illuminated by the dispersed spectrum on the micromirror array.

### FIGS. 18A, 18B: Cross-Connect 250

FIG. 18A shows an exemplary embodiment of a cross-connect generally indicated as 250 that is similar to the cross-connect 10 of FIG. 2A, and therefore similar components have the same reference numeral. In effect, in this embodiment the effective curvature of the micro-mirror device 200 is compensated for using a “field correction” lens 222. The field correction lens 222 is disposed optically between respective bulk lens 28, 52 and the spatial light modulator 252, which includes micro-mirror device 200. The “field correction” lens 222 respectively compensate for the channels reflecting off the spatial light modulator 252.

FIG. 18B shows an alternative embodiment to that shown in FIG. 18A, wherein the DMD device 30 is oriented so that the mirrors 84 tilt on an axis that is perpendicular to the spectral axis 86. (As shown, the spatial axis 85′ runs into and out of FIG. 18B.) This embodiment is particularly important when implementing the chisel prism arrangement discussed below in relation to FIGS. 34-36. Similar elements in FIGS. 18A and 18B are labelled with similar reference numerals.

### FIG. 19: 45° Rotation of Micro-Mirror Device

As described hereinbefore, the micro-mirrors 84 of the micro-mirror device 200 flip about a diagonal axis 205 as shown in FIGS. 13 and 19. In an exemplary embodiment of the present invention shown in FIG. 19, the optical input channels 14, 14′ are focused on the micro-mirror device 200 such that the spectral axis 86 of the optical channels 14, 14′ is parallel to the tilt axis 205 of the micro-mirrors. This configuration is achieved by rotating the micro-mirror device 45 degrees compared to the configuration shown in FIG. 4A.

Alternatively, the optical channels 14, 14′ may be focused such that the spectral axis 86 of the channels are perpendicular to tilt axis 205 of the micro-mirrors similar to that shown in FIGS. 9 and 10. Further, one will appreciate that the orientation of the tilt axis 205 and the spectral axis 86 may be at any angle.

### FIGS. 20-21: Ringing of Mirror During Transition

FIGS. 20 and 21 illustrate the effect of the ringing of micro-mirrors during their transition.

In the operation of the micro-mirror device 200 manufactured by Texas Instruments, described hereinbefore, all the micro-mirrors 84 of the device 200 release when any of the micro-mirrors are flipped from one position to the other. In other words, each of the mirrors will momentarily tilt towards the horizontal position upon a position change of any of the micro-mirrors. Consequently, this momentary tilt of the micro-mirrors 84 creates a ringing or flicker in the light reflecting off the micro-mirrors. To reduce or eliminate the effect of the ringing of the light during the transition of the micro-mirrors 84, the light is focused tightly on the micro-mirror device 200. FIGS. 20 and 21 illustrate the effect of the ringing of micro-mirrors during their transition. Both FIGS. 20 and 21 show an incident light beam 310, 312, respectively, reflecting off a mirror surface at different focal lengths. The light beam 310 of FIG. 12 has a relatively short focal length, and therefore has a relatively wide beam width. When the micro-mirror surface 314 momentarily tilts or rings a predetermined angle ô, the reflected beam 316, shown in dashed lines, reflects off the mirror surface at the angle ô. The shaded portion 318 is illustrative of the lost light due to the momentary ringing, which represents a relatively small portion of the incident light 310. In contrast, the light beam 312 of FIG. 21 has a relatively long focal length, and therefore has a relatively narrow beam width. When the micro-mirror surface 314 momentarily tilts or rings a predetermined angle ô, the reflected beam 320, shown in dashed lines, reflects off the mirror surface at the angle ô. The shaded portion 322 is illustrative of the lost light due to the momentary ringing, which represents a greater portion of the incident light 312, than the lost light of the incident light of FIG. 20. Consequently, the sensitivity of the momentary tilt of the micro-mirrors is minimized by tightly focusing the optical channels on the micro-mirror device 200. Advantageously, tightly focusing of the optical channels also reduces the tilt sensitivity of the micro-mirror device due to other factors, such as thermal changes, shock and vibration.

### FIGS. 22-25b: Cross-Connect 350

FIGS. 22-25b show another exemplary embodiment of a cross-connect generally indicated as 350 that is similar to the cross-connect 10 of FIG. 2A having a micro-mirror device 200 of the spatial light modulator 300, and therefore, similar components have the same reference numerals. The cross-connect 350 directs both the first input signal 12 and second input signal 13 through a set of common optical components. To better understand the cross-connect 350, a side elevational view of the input optical components 18, 20 and the common optical components 22, 24, 26, 28, 300 are illustrated in FIG. 23.

As shown in FIG. 23, the optical components are disposed in two tiers or horizontal planes. Specifically, the first three-port circulator 18, the first pigtail 20, the collimator 22 and the diffraction grating 24 are disposed in a first tier or horizontal plane. As will be appreciated, the second circulator 66 and the second pigtail 64 are disposed in the first tier. The mirror 26, the bulk lens 28 and the spatial light modulator 200 are disposed in the second tier or horizontal plane. Further, the mirrors 352, 354 and the lens 356, 358 of FIG. 22 are disposed in the second tier.

Referring to FIGS. 22 and 23, the first circulator 18 directs the first input signal 12 from the optical fiber 38 to the first pigtail 20. The first input signal 12 exits the first pigtail (into free space) and passes through the collimator 22, which collimates the first input signal. The collimated input signal 40 is incident on the diffraction grating 24, which separates spatially the optical input channels 14 of the collimated input signal 40 by diffracting or dispersing the light from the diffraction grating. As best shown in FIG. 23, the diffraction grating 24 directs the separated light 44 to the mirror 26 disposed in the second tier. The mirror 26 reflects the separated light 44 to the bulk lens 28 (e.g., a Fourier lens), which focuses the separated light onto the micro-mirror device 200 of the spatial light modulator 300, as shown in FIG. 24. In response to a switching algorithm and input command 46, the micro-mirror device 200 of the spatial light modulator 300 selectively reflects each input channel 14 of the first input signal 12 in one of two optical paths 360, 362 away from the bulk lens 28 through a pair of respective focusing lens 356, 358 to corresponding mirrors 352, 354.

As will be described in greater detail hereinafter, the input channels directed along the optical path 360 reflect back to the first pigtail 20 to provide the first output signal 48 at optical fiber 50, while the input channels directed along the optical path 362 are redirected to the second optical pigtail 64 to provide the second output signal 76 at optical fiber 74.

Similarly, the input channels 14′ of the second input signal 13 propagate through the common optical components to the micro-mirror device 200 of the spatial light modulator 300, which selectively reflects each input channel 14′ in one of the two optical paths, as described hereinbefore. The input channels 14′ directed along the optical path 360 reflect back to the first pigtail 20 to be added to the first output signal 48 at optical fiber 50, while the input channels 14′ directed along the optical path 362 are redirected to the second optical pigtail 64 to provide the second output signal 76 at optical fiber 74.

FIG. 24 illustrates the outline of the optical input channels 14 of the first input signal 12 and input channels 14′ of the second input signal 21, which are dispersed off the diffraction grating 24 and focused by the bulk lens 28 onto the array of micro-mirrors 84 of the micro-mirror device 200. The input channels 14, 14′ are spectrally separated and have a generally circular cross-section, such that the optical channels 14, 14′ of each respective input signal 12, 13 do not substantially overlap spatially when focused onto the micro-mirror device 200. Further, the ends 36, 72 are positioned (e.g., spatially spaced) such that the input channels 14, 14′ are initially focused onto different groups of mirrors. In other words, the spectrum of the first input channels 14 and the spectrum of the second input channels 14′ are spaced spatially along the spatial axis 88.

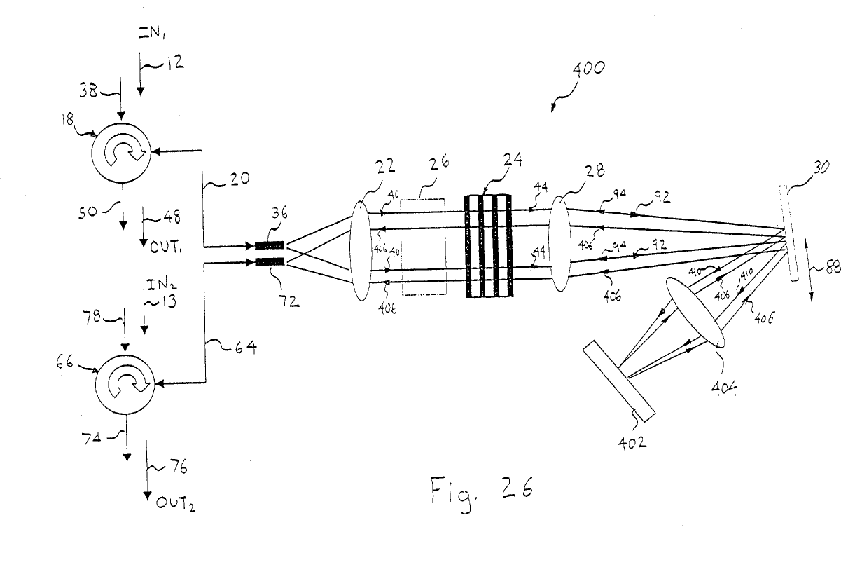

Further, FIG. 24 is illustrative of the position of the micro-mirrors 84 of the micro-mirror device 200 for switching the input channels 14, 14′ at λ₂ and λ₅, for example. The outline of each channel 14, 14′ is shown to provide a reference to visually locate the groups of tilted mirrors 370 and 372. As shown, the group of mirrors 370 and 372 associated with each respective optical channel 14, 14′ at λ₂ and λ₅, are tilted away from the incident light 92 to the second position (see FIG. 25), as indicated by the blackening of the micro-mirrors 84 to the mirror 354. Each group of tilted mirrors 370, 372 provides a generally rectangular shape. In an exemplary embodiment, the group of micro-mirrors 370 and 372 reflects substantially all the light of each respective input channel 14, 14′ and does reflect substantially no light of any adjacent channels. The distance between the micro-mirror device and the mirror 354 is approximately two times the focal length (i.e., 2f), which causes the input channels 14, 14′ to switch spatially such that the first input channel 14 reflects off the micro-mirror device 200 through the second pigtail 64 to the second output 74, while the second input channel 14′ reflects off the micro-mirror device through the first pigtail 20 to the first output 50.

Conversely, the micro-mirrors 84 of the other optical input channels 14, 14′ at wavelengths of λ₁, λ₃, λ₄, λ₆-λ_{N} are disposed in the first position, as indicated by the white micro-mirrors, to reflect the light 92 along the optical path 360 to the mirror 352. The distance between the micro-mirror device and the mirror 352 is approximately four times the focal length (i.e., 4f), which causes the first input channel 14 and the second input channel 14′ to return to the same group of micro-mirrors 84 such that the first input channel 14 reflects off the micro-mirror device 200 back through the first pigtail 20 to the optical fiber 50, while the second input channel 14′ reflects off the micro-mirror device back through the second pigtail 64 to the second output 74.

As shown in FIG. 25a, the micro-mirror device 200 is oriented to reflect the focused light 92 of selected input channels 14 and/or input channels 14′ to mirror 354, as indicated by arrows 362, which are then reflected back along corresponding optical paths 376, as described hereinbefore, when the micro-mirrors 84 are disposed in the second position. As shown in FIG. 25b, the focused light 92 of selected input channels 14 and/or input channels 14′ reflects off the micro-mirror device 200 to mirror 352, as indicated by arrows 360, which are then reflected back along the same optical paths, as described hereinbefore, when the micro-mirrors 84 are disposed in the first position. It should be realized that with astigmatic optics, mirrors 352, 354, could be tilted such that the return beams are displaced from the input pigtails 20, 64 and can be received by a second set of output pigtails eliminating the need for circulators 18, 66.

### FIG. 26: Cross-Connect 400

FIG. 26 shows another exemplary embodiment of a cross-connect 400 that is similar to the cross-connect 10 of FIG. 2A, and therefore, similar components have the same reference numerals. The cross-connect 400 directs both the first input signal 12 and the second input signal 13 through a set of common optical components. The optical components are disposed in two tiers or horizontal planes similar to the embodiments discussed hereinbefore. Specifically, the three-port circulators 18, 66, the pigtails 20, 64, the collimator 22 and the diffraction grating 24 are disposed in a first tier or horizontal plane. The mirror 26, the bulk lens 28 and the spatial light modulator 30 are disposed in the second tier or horizontal plane, which is parallel to the first horizontal plane. Further, the mirror 402 and the lens 404 of FIG. 26 are disposed in the second tier.

The first circulator 18 directs the first input signal 12 from the optical fiber 38 to the first pigtail 20. The first input signal 12 exits the first pigtail (into free space) and passes through the collimator 22, which collimates the input signal 14. The collimated input signal 40 is incident on the diffraction grating 24, which separates spatially the optical input channels 14 of the collimated input signal 40 by diffracting or dispersing the light from the diffraction grating. The diffraction grating 24 directs the separated light 44 to the mirror 26 disposed in the second tier. The mirror 26 reflects the separated light 44 to the bulk lens 28 (e.g., a Fourier lens), which focuses the separated light onto the micro-mirror device 82 of the spatial light modulator 30, as shown in FIG. 3. In response to a switching algorithm and input command 46, the spatial light modulator 300 selectively reflects each input channel 14 through the lens 404 to the mirror 402, or back through the common optical components to pigtail 20.

In the operation of the cross-connect 400, the micro-mirrors 84 of the spatial light modulator 30 are tilted to a first position to reflect selected input channels 14 of the input signal 12 back along the return path 94 to provide the first output signal 48 at optical fiber 50. The micro-mirrors 84 of the spatial light modulator 30 are tilted to a second position to reflect the remaining input channels 14 through the lens 404 to the mirror 402. The mirror 402 is tilted such that the remaining input channels 14 are reflected along a slightly different path, as indicated by arrows 406 than the return path 94. The remaining input channels 14 propagate to the second pigtail 72, as indicated by arrows 406, to be added to the second output signal 76 at the optical fiber 74.

Similarly, the optical input channels 14′ of the second input signal 13 propagate through the common optical components to the micro-mirror device 82 of the spatial light modulator 30, which selectively reflects each input channel 14′ in one of the two optical paths, as described hereinbefore. The input channels 14′ directed along the optical return path 94 reflect back to the first pigtail 20 to be added to the first output signal 48 at optical fiber 50, while the remaining input channels 14′ directed along the optical path 410 are redirected to the mirror 402 and reflected back to the second optical pigtail 64 along the optical path 406 to provide the second output signal 76 at optical fiber 74.

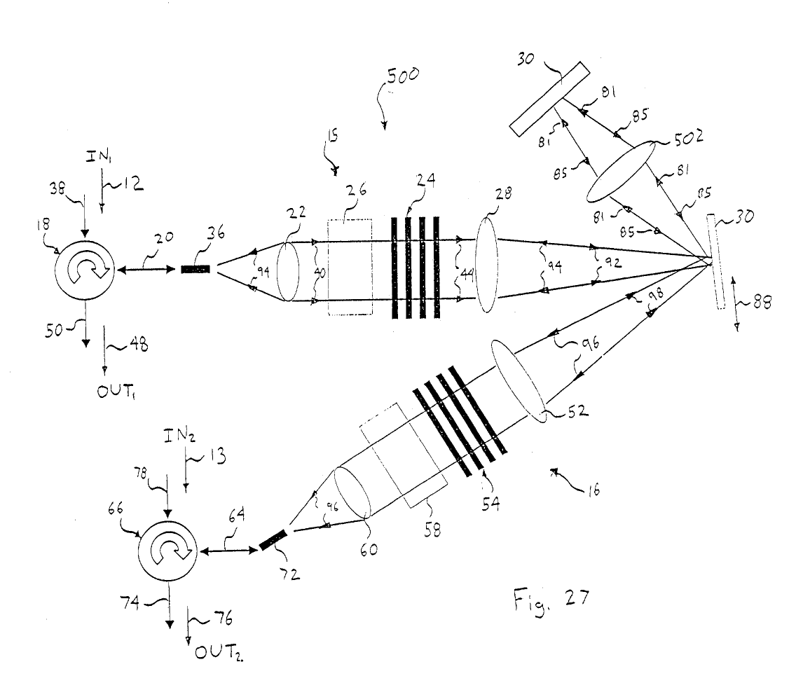

### FIG. 27: Cross-Connect 500

FIG. 27 shows another exemplary embodiment of a cross-connect 500 that is similar to the cross-connect 10 of FIG. 2A, except a focusing lens 502 is provided between the spatial light modulator 30 and the mirror 83. Similar components have the same reference numerals. The cross-connect 500 operates similarly to the cross-connect 10.

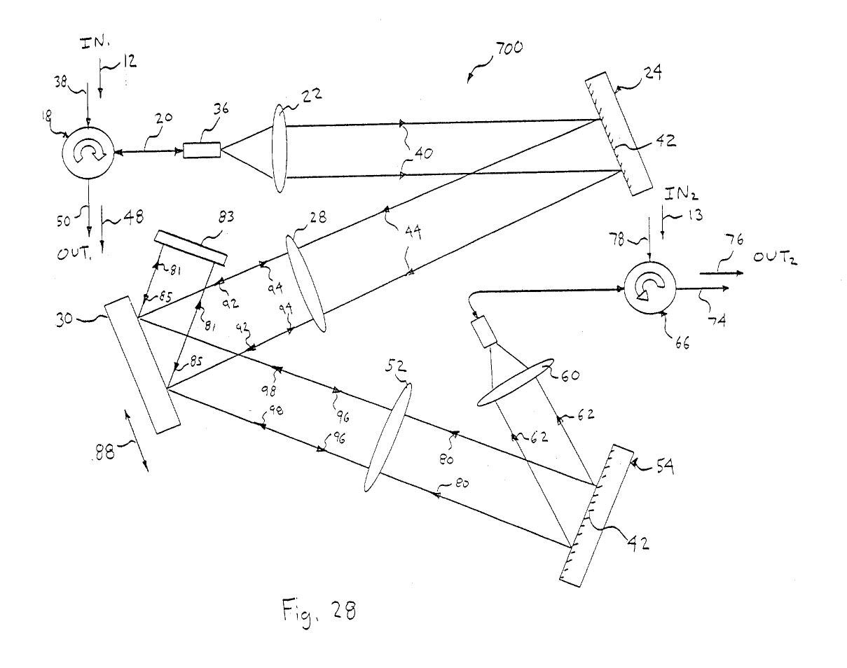

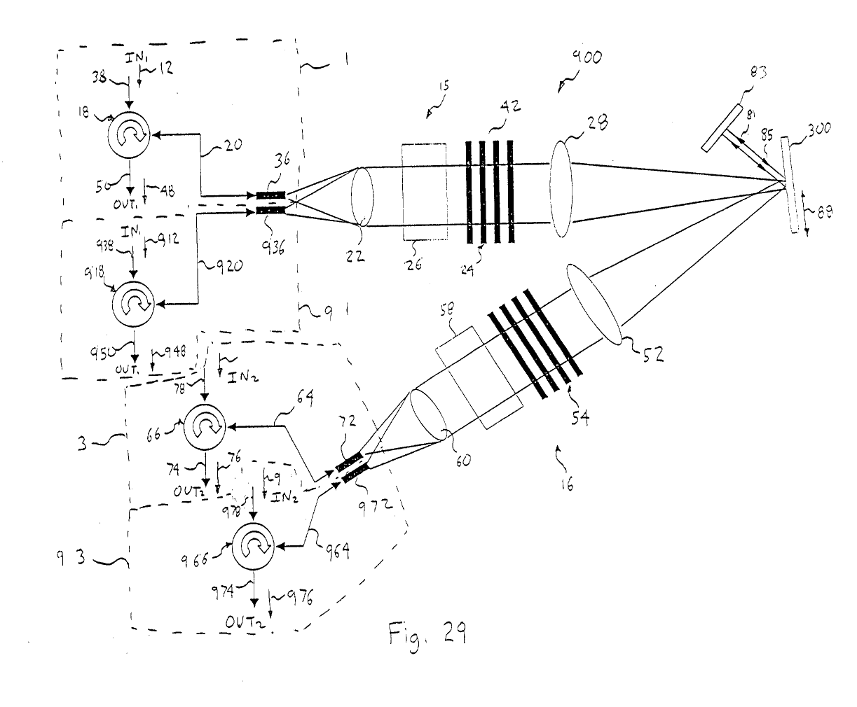

### FIG. 28: Cross-Connect 700

FIG. 28 shows another exemplary embodiment of a cross-connect 700 that is similar to the cross-connect 170 of FIG. 9, and therefore, similar components have the same reference numerals. The cross-connect 700 operates similarly to the cross-connect 170 except the first diffraction gratings 24, 54 are rotated 90 degrees so that the input channels 14 of first input signal 12 and input channels 14′ of second input signal 13 are dispersed on micro-mirror device 82 of the spatial light modulator 30 such that the spectral axis 86 of optical channels 14, 14′ are perpendicular to the horizontal plane that the optical components of the cross-connect 700 are disposed. Further, the diffraction grating 54 is tilted at a predetermined angle to reflect the optical channels 14, 14′0 in an optical path 62 (upward as shown in FIG. 28) to equalize the path length of each of the optical channels through the cross-connect 700.

While the embodiments of the present invention described hereinabove illustrate a single cross-connect using a set of optical components, it would be advantageous to provide an embodiment including a plurality of cross-connects that uses a substantial number of common optical components, including the spatial light modulator.

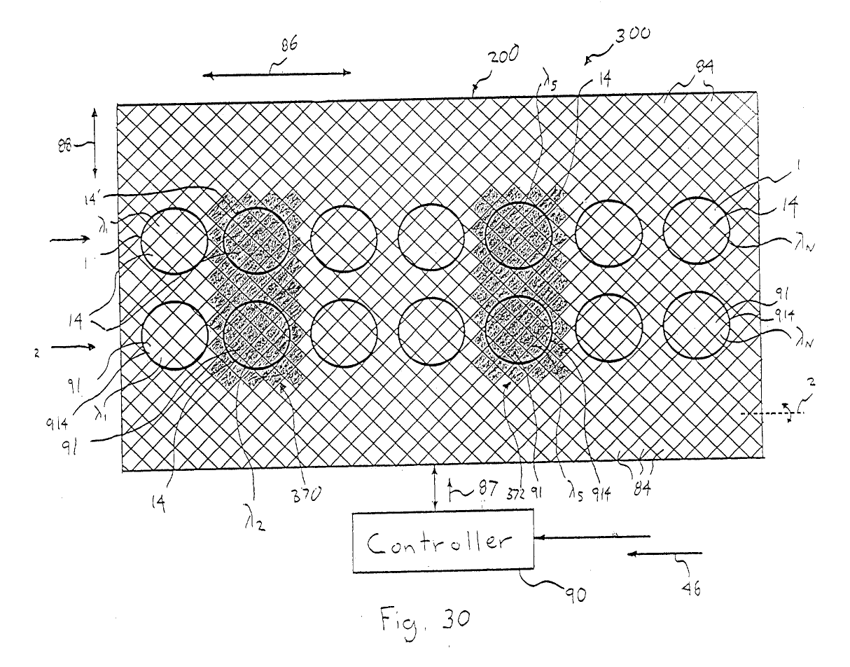

### FIGS. 29-30: Cross-Connect 900

FIG. 29 illustrates such an embodiment of a cross-connect 900, which is substantially the same as the cross-connect 10 in FIG. 2A having a spatial-light modulator 300 in FIG. 12. Common components between the embodiments have the same reference numerals. The cross-connect 400 provides a pair of cross-connects (i.e., X-CON₁, XCON₂), each of which use substantially all the same optical components, namely the collimating lens 22, 60, the mirrors 26, 58, the diffraction gratings 24, 54, the bulk lens 28, 52 and the spatial light modulator 300. The first cross-connect (X-CON₁) is substantially the same as the cross-connect 10 of FIG. 11. The second cross-connect (X-CON₂) is provided by adding a complementary set of input optical components 981, 983. The input optical components 91, 93 of X-CON₁ and the input optical components 991, 993 of X-CON₂ are the same, and therefore have the last two numerals of the input optical components 991, 993 of X-CON₂ are the same as those of the similar components 91, 93 of the X-CON₁.

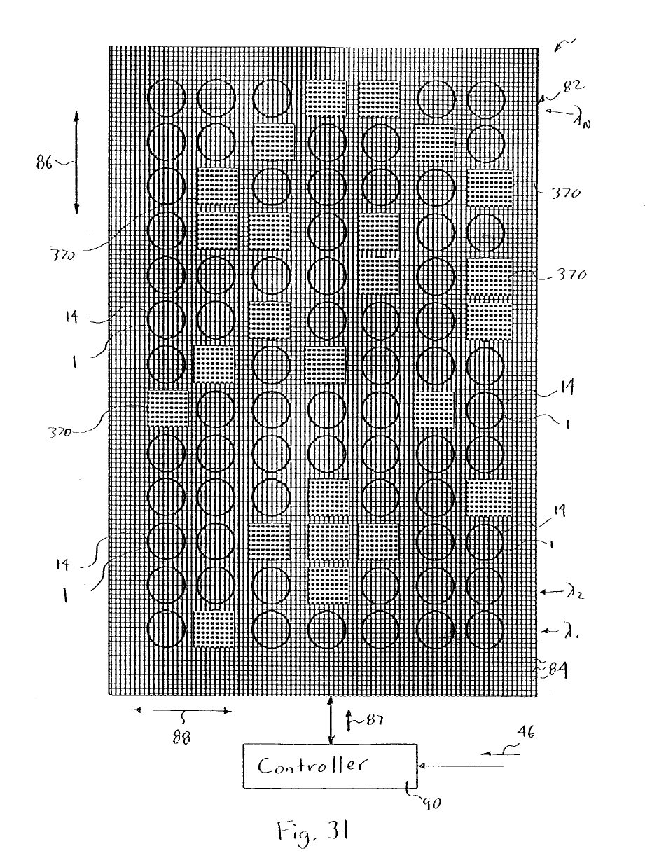

To provide a plurality of cross-connects (X-CON₁, X-CON₂) using similar components, each cross-connect uses a different portion of the micro-mirror device 200, as shown in FIG. 30, which is accomplished by displacing spatially the ends 36, 72, 936, 972 of the pigtails 20, 64, 920, 964 of the cross-connects. As shown, the input channels 14, 14′, 914, 914′ of each cross-connect are displaced a predetermined distance in the spatial axis 88. Similar to that described hereinabove, the groups 370, 372 of shaded micro-mirrors 84 drop and/or add optical channels at λ₂ and λ₅ of both cross-connects (X-CON₁, X-CON₂). One will recognize that while the same optical channels 14, 14′, 914, 914′ are switched in the embodiment shown in FIG. 30, the micro-mirrors 84 may be tilted to individually switched different optical channels 14, 14′, 914, 914′9 as shown in FIG. 31.

### FIG. 31

FIG. 31 illustrates another embodiment of the present invention similar to that shown in FIG. 30, wherein the embodiment has N number of cross-connects (X-CON₁-X-CON_{N}) using substantially the same optical components, as described hereinabove.

### Micro-Mirror Switching

While the micro-mirrors 84 may switch discretely from the first position to the second position, as described hereinabove, the micro-mirrors may move continuously (in an “analog” mode) or in discrete steps between the first position and second position. In the “analog” mode of operation the micro-mirrors can be tilted in a continuous range of angles. The ability to control the angle of each individual mirror has the added benefit of much more attenuation resolution than in the digital control case. In the “digital” mode, the attenuation step resolution is determined by the number of micro-mirrors 84 illuminated by each channel. In the “analog” mode, each mirror can be tilted slightly allowing fully continuous attenuation of the return beam. Alternatively, some combination of micro-mirrors may be switched at a predetermined or selected pulse width modulation to attenuate the optical channel or band.

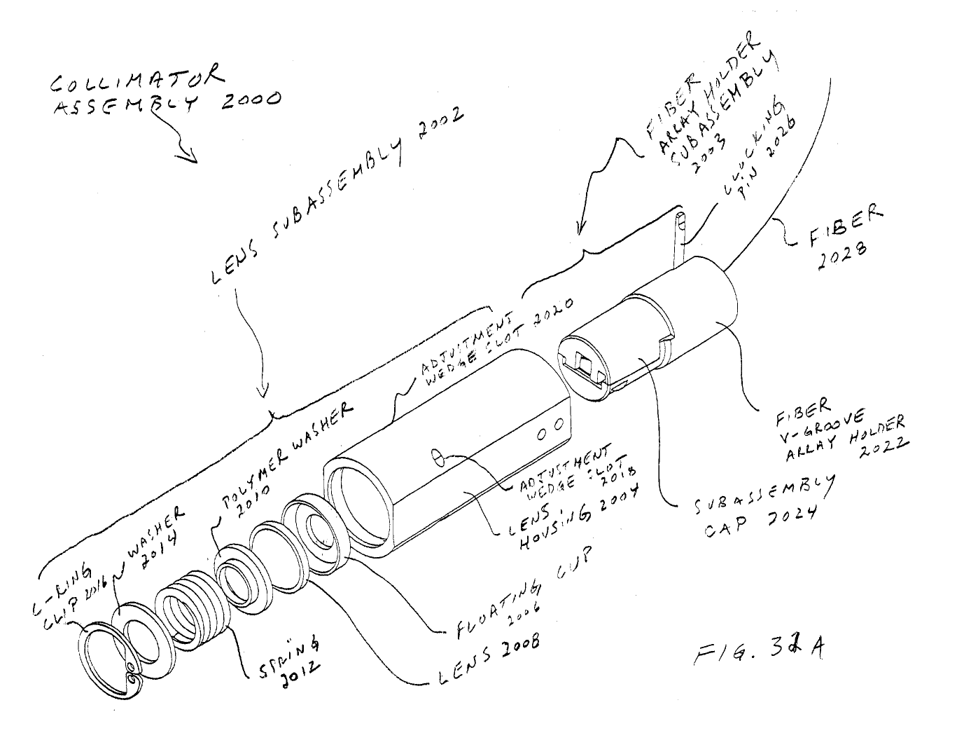

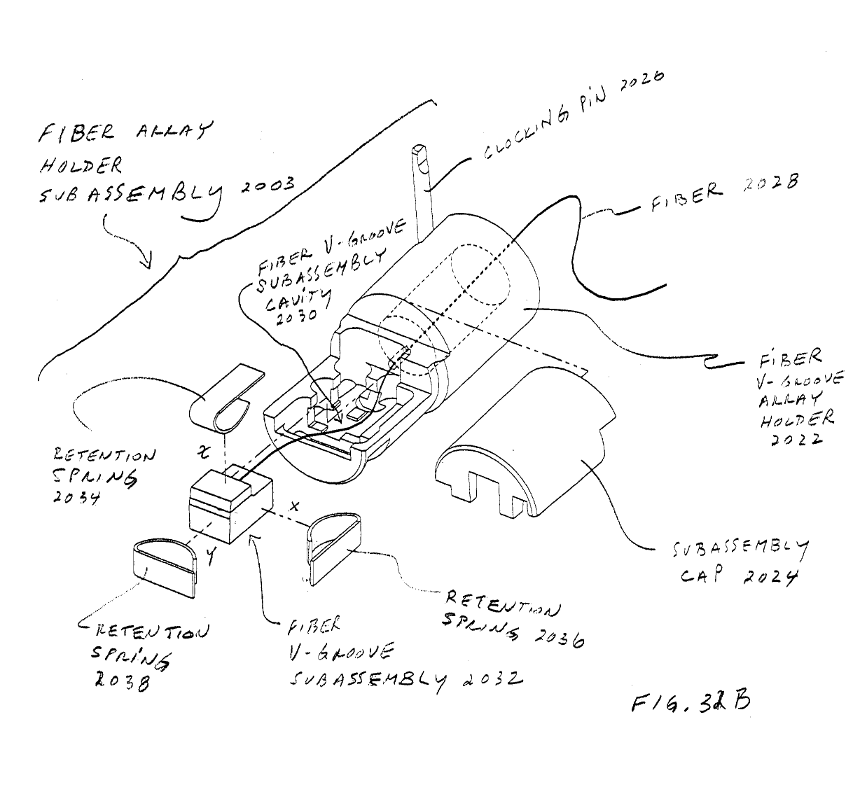

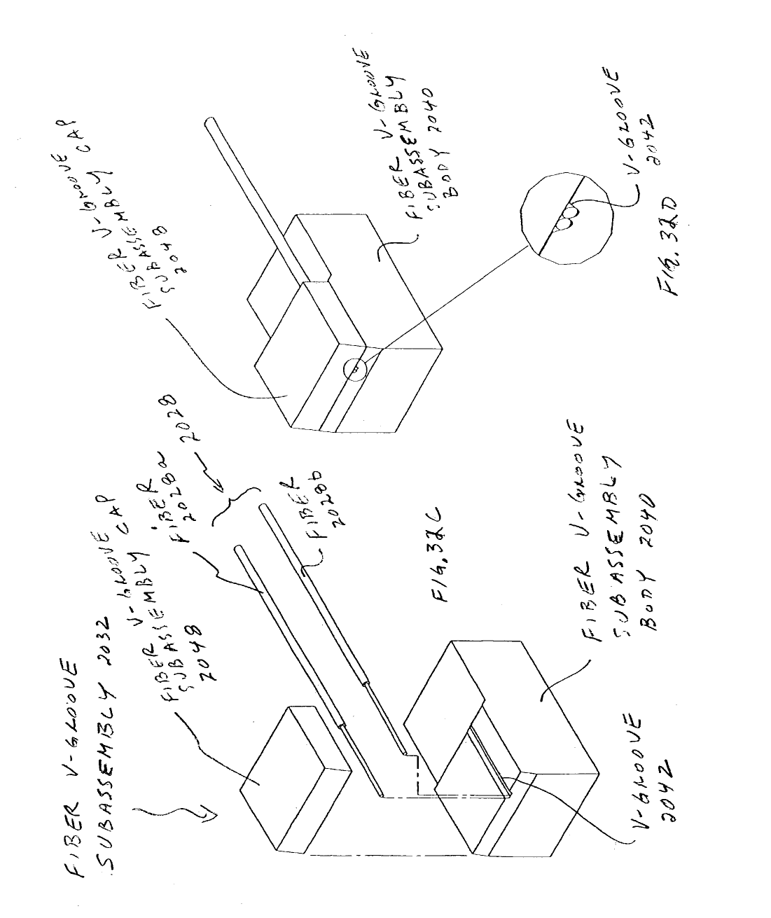

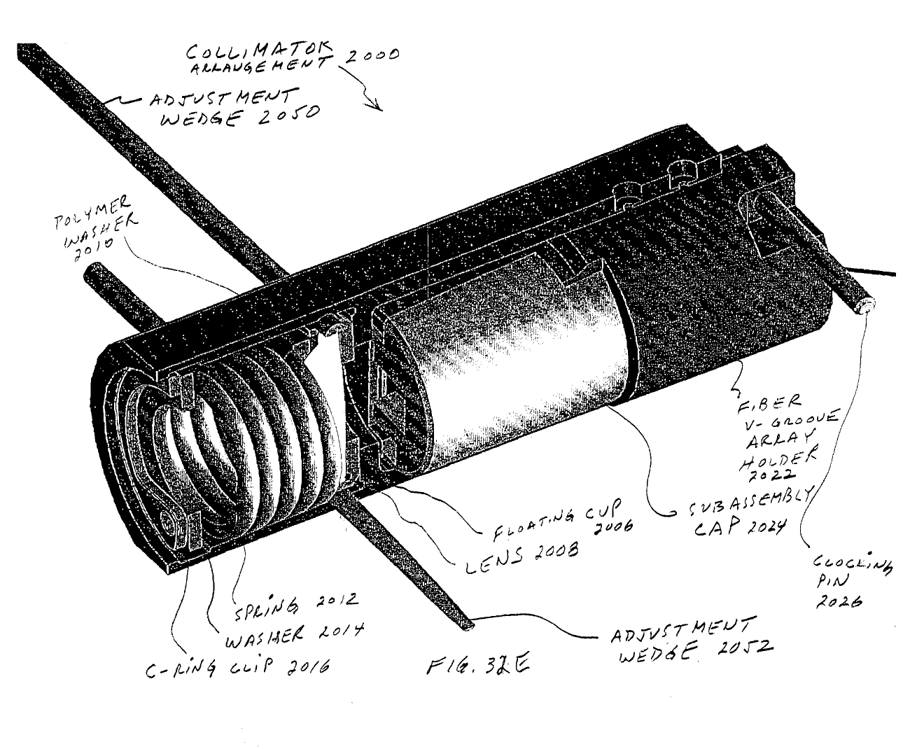

### FIGS. 32A-32E: The Collimator Assembly

FIG. 32A shows a collimator assembly generally indicated as 2000. The collimator assembly 2000 may be used in place of the arrangement of either the capillary tube 36 and the collimator lens 22, the capillary tube 72 and the collimator lens 60, the capillary tube 636 and the collimator lens 622, the capillary tube 936 and the collimator lens 22, the capillary tube 972 and the collimator lens 60, or any combination thereof, in any one or more of the embodiments described above.

The collimator assembly has a lens subassembly 2002 and a fiber array holder subassembly 2003. The lens subassembly 2002 includes a lens housing 2004 for containing a floating lens cup 2006, a lens 2008, a polymer washer 2010, a spring 2012, a washer 2014 and a C-ring clip 2016. The lens housing 2004 also has two adjustment wedge slots 2018, 2020. The fiber array holder subassembly 2003 includes a fiber V-groove array holder 2022, a subassembly cap 2024 and a clocking pin 2026. The fiber 2028 is arranged in the fiber array holder subassembly 2003. The V-groove array holder 2022 is designed to place the one or more fibers 2028 on the nominal origin of an optical/mechanical access. The clocking pin 2026 sets the angle of a semi-kinematic mount, and therefore the angle of the one or more fibers 2028 relative to the nominal optical and/or mechanical access.

FIG. 32B shows the fiber array holder subassembly 2003 having a fiber V-groove subassembly cavity generally indicated as 2030 for mounting a fiber V-groove subassembly generally indicated as 2032. The fiber V-groove subassembly 2032 is semi-kinematically mounted and maintained in the fiber V-groove subassembly cavity 2030 by three retention springs 2034, 2036, 2038 and the subassembly cap 2024. For example, the mounting of the fiber V-groove subassembly 2032 is characterized as follows: (1) the precision substrate of fiber V-groove array is arranged in the fiber V-groove subassembly cavity 2030; (2) The retention spring 2036 restrains the fiber V-groove subassembly 2032 in the X direction; (3) the two retention springs 2034, 2038 constrain the fiber V-groove subassembly 2032 in the Y and Z directions; and (4) the subassembly cap 2024 is welded to the fiber V-groove array holder 2022 to complete retention of the fiber V-groove subassembly 2032 in a semi-kinematic mount.

FIGS. 32C and D show, by way of example, the fiber V-groove subassembly 2032 having a fiber V-groove subassembly body 2040 having a V-groove 2042 arranged therein for receiving the one or more fibers 2028a, 2028b. The fiber V-groove subassembly 2032 also has a fiber V-groove subassembly cap 2048 for enclosing and holding the fibers 2028a, 2028b in the V-groove 2042, as best shown in FIG. 32D.

FIG. 32E shows a complete collimator assembly generally indicated as 2000. In the complete collimator assembly 2000, the lens subassembly 2002 is welded to the fiber array holder subassembly 2003. The fully welded collimator assembly 2000 is mounted on a mounting or focusing tool or configuration (not shown) for providing coarse optical/mechanical alignment. Control of the basic mechanics of the mounting configuration is typically in the range of about +/−25 microns and about 0.1°. However, initial and final positioning of other optical components on the mounting configuration require a coarse adjustment of the actual access of the collimator assembly 2000 to match with the optical access of the other components. The coarse adjustment of the collimator optical access is achieved by moving the lens 2008 in the X and Y directions while maintaining a fixed position of the fiber array holder subassembly 2003. Tuning wedges 2050, 2052 are used to move the lens floating cap 2006 in the X and Y directions to provide coarse lens adjustment to about +/−500 microns, as discussed below. However, with use of a piezoelectric impact tool fine displacement with a resolution that is a small fraction of about a micron may be achievable.

The collimator assembly is assembled as follows:

First, the lens subassembly 2002 is assembled. The lens 2008 sits in the floating lens cup 2006. The interfaces between the floating lens cup 2006 and the precision tube of the lens housing 2004 are precision ground. The polymer washer 2014 restrains the lens 2008 in the floating lens cup 2006 under force from the compression spring 2012. The washer 2014 and the C-ring clip 2016 are used to provide a reaction surface so that the compression spring 2012 can hold the floating lens cup 2006 against the interface with the inner surface of the subassembly tube of the lens housing 2004. The lens housing has notches 2018, 2020 to accommodate use of the tuning wedges 2050, 2052. As discussed below, the tuning wedge 2050, 2052 may be inserted into the notches 2018, 2020 so as to react against the surface in order to push the floating lens cup 2006 in adjustment relative to the mechanical access of the tube of the lens housing 2004.

Next, the array holder 2022 is fit into the precision tube of the lens housing 2004 for a focus adjustment and weld. To accomplish the collimation adjustment, the array holder 2022 and the tube of the lens housing 2004 are installed into the focusing tool (not shown) along with the lens subassembly 2002. The lens subassembly 2002 is aligned and adjusted for optimum collimation. The array holder 2022 is welded to the precision tube of the lens housing 2004. At this point, the lens subassembly 2004 and the fiber array holder subassembly 2003 are a matched pair.

In operation, the collimator assembly 2000 will interface optical signals on an optical fiber with the optics of another optical device by creating a parameter-matched, free space beam; collect a returning beam from the other optical device and re-introduce it into the optical fiber with minimal loss; interface the collimator on the other optical device chassis with accuracy of about +/−25 microns and about +/−1 mR; point the free space beam into the optical access of the other optical device with a coarse adjustment of about +/−2 mR and a fine adjustment of about +/−0.002 mR. Moreover, adhesives are not allowed in the optical path and are not desired for connecting any of the precisely aligned optical/mechanical components.

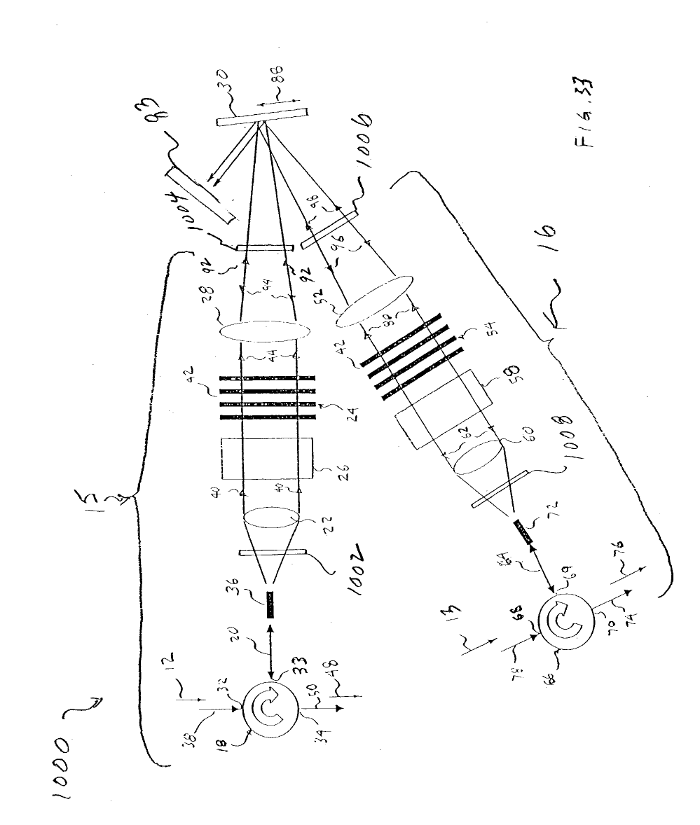

### FIG. 33: Polarization Dependence Loss (PDL) and λ/4 Plate Solution

FIG. 33 shows an embodiment of a cross-connect generally indicated as 1000 having optical portions 15, 16 with one or more optical PDL devices 1002, 1004, 1006, 1008 for minimizing polarization dependence loss (PDL). The one or more optical PDL devices 1002, 1008 are arranged between the capillary tube 36 and the collimator 22, while the one or more optical PDL devices 1004, 1006 are arranged between the bulk lens 38 and the spatial light modulator 30.

The optical PDL device 1002 may include a polarization splitter for splitting each channel into its pair of polarized light beams and a rotator for rotating one of the polarized light beams of each optical channel. The optical PDL device 1008 may include a rotator for rotating one of the previously rotated and polarized light beams of each optical channel and a polarization splitter for combining the pair of polarized light beams of each channel.

The one or more optical devices 1002, 1004, 1006, 1008 may be incorporated in any of the embodiments shown and described above, including but not limited to the embodiments shown in FIGS. 1, 1A, 7A, 7B, 7C, 8, 17, 17A, 23, 27-31 and 33.

In effect, as a person skilled in the art will appreciate, a diffraction grating such as the optical elements 42, 54 has a predetermined polarization dependence loss (PDL) associated therewith. The PDL of the diffraction grating 24 is dependent on the geometry of the etched grooves 42 of the grating. Consequently, means to mitigate PDL may be desired. The λ/4 plate between the spatial light modulator 30 and the diffraction grating(s) 24, 54 (before or after the bulk lens 28, 52) mitigates the PDL for any of the embodiments described hereinbefore. The fast axis of the λ/4 plate is aligned to be approximately 45 degrees to the direction or axis of the lines 42 of the diffraction grating 24. The mirror is angled to reflect the separated channels back through the λ/4 plate to the diffraction grating. In the first pass through the λ/4 plate, the λ/4 plate circularly polarizes the separated light. When the light passes through the λ/4 plate again, the light is linearly polarized to effectively rotate the polarization of the separated channels by 90 degrees. Effectively, the λ/4 plate averages the polarization of the light to reduce or eliminate the PDL. One will appreciate that the λ/4 plate may not be necessary if the diffraction grating has low polarization dependencies, or other PDL compensating techniques are used that are known now or developed in the future.

As shown and described herein, the polarized light beams may have a generally circular cross-section and are imaged at separate and distinct locations on the spatial light modulator 30, such that the polarized light beams of the optical channels do not substantially overlap spatially when focused onto the spatial light modulator, as shown, for example, in FIGS. 6, 18, 25, 34 and 35.

### FIG. 34: The Chisel Prism

FIG. 34 shows a cross-connect generally indicated as 1600 similar to that shown above, except that the micromirror device is oriented such that the tilt axis 85 is perpendicular to the spectral axis 86. The cross-connect has a chisel prism 1602 arranged in relation to the spatial light modulator 30 as well as a set of optical components 1604 and a complimentary set of optical components 1606. The underlying configuration of the cross-connect 1600 may be implemented in any of the embodiments show ad described in relation to FIGS. 3, 8B, 8C and 18A described above in which the pivot or tilt axis of the mirrors of the DVD device is perpendicular to the spectral axis of the channels projected on the DVD device.

The set of optical components 1604 and the complimentary set of optical components 1606 are similar to the optical portions 15, 16 shown and described herein. For example, see FIG. 1. The spatial light modulator 30 is shown and described herein as the well known DMD device. The chisel prism 1602 has multiple faces, including a front face 1602a, first and second beveled front faces 1602b, 1602c, a rear face 1602d and a bottom face generally indicated by 1602e. (It is noted that in embodiments having no retroflector only two front faces are used, and in embodiments having a retroflector all three front faces are used.) Light from the set of optical components 1604 and the complimentary set of optical components 1606 passes through one or more faces of the chisel prism 1602, reflects off the spatial light modulator back-to the chisel prism 1602, reflects off one or more internal surfaces of the chisel prism 1602 and passes back through the chisel prism 1602, passes back to the set of optical components 1604 or the complimentary set of optical components 1606.

The chisel prism design described herein addresses a problem in the optical art when using DMD devices. The problem is the ability to send a collimated beam out to a reflective object and return it in manner that is insensitive to the exact angular placement of the reflective object. Because a light beam is typically collimated and spread out over a relatively large number of micromirrors, any overall tilt of the array causes the returned beam to “miss” the optical component, such as a pigtail, intended to receive the same.

The present invention provides a way to reduce the tilt sensitivity by using a classical optical design that certain combinations of reflective surfaces stabilize the reflected beam angle with respect to angular placement of the reflector. Examples of the classical optical design include a corner-cube (which stabilize both pitch and yaw angular errors) or a dihedral prism (which stabilize only one angular axis.).

One advantage of the configuration of the present invention is that it removes the tilt sensitivity of the optical system (which may comprise many elements besides a simple collimating lens such as element 26 shown and described above) leading up to the retro-reflective spatial light modulator 30. This configuration allows large beam sizes on the spatial light modulator without the severe angular alignment sensitivities that would normally be seen.

Patent application Ser. No. ______ (CC-0461), which is hereby incorporated by reference, shows and describes the basic principal of these highly stable reflective elements in which all the surfaces of the objects being stable relative to one another, while the overall assembly of the surfaces may be tilted without causing a deviation in reflected angle of the beam that is large compared to the divergence angle of the input beam.

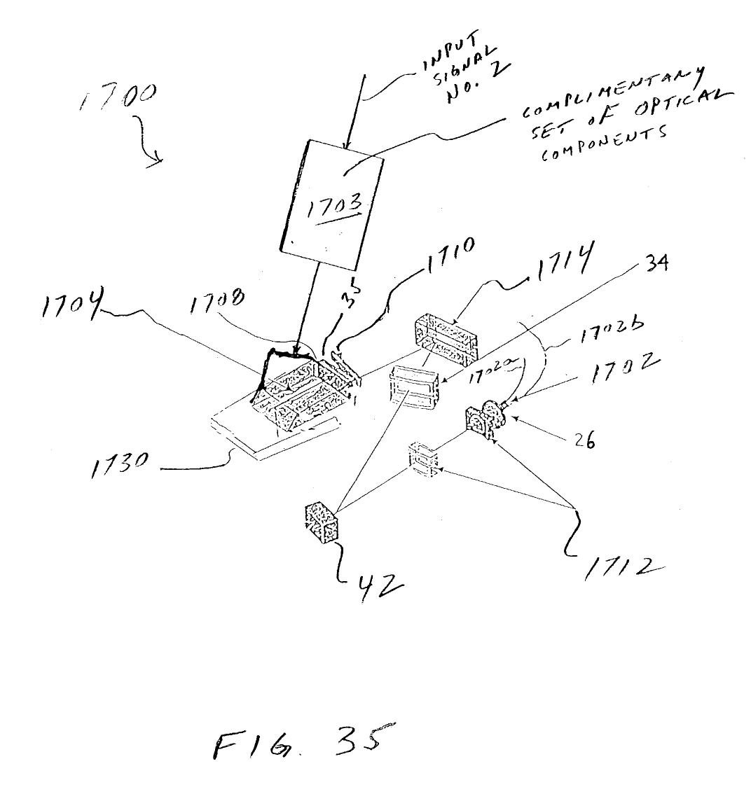

### FIG. 35:

FIG. 35 illustrates a schematic diagram of a cross-connect generally indicated as 1700 having a chisel prism 1704 that provides improved sensitivity to tilt, alignment, shock, temperature variations and packaging profile, which incorporates such a tilt insensitive reflective assembly.

Similar to the embodiments described hereinbefore, the cross-connect 1700 includes a first set of optical components having a dual fiber pigtail 1702 (circulator free operation), the collimating lens 26, a bulk diffraction grating 42, a Fourier lens 34, a ¼λ plate 35, a reflector 26 and a spatial light modulator 1730 (similar to that shown above). The dual fiber pigtail 601 includes a transmit fiber 1702a and a receive fiber 1702b. The first set of optical components typically provide a first optical input signal having one or more optical bands or channels on the receive fiber 1702b, as well as providing an optical output signal on the transmit fiber 1702b.

Similar to the embodiments described hereinbefore, the cross-connect 1700 also includes a complimentary set of optical components 1703 for providing a second optical input signal, which is typically an optical signal to be added to the first optical input signal.

Similar to the embodiment described above, the chisel prism 1704 has multiple internally reflective surfaces, including a top surface, and a back surface, as well as transmissive surfaces including three front surfaces and a bottom surface, similar to that shown in FIG. 34. The micro-mirror device 1730 is placed normal to the bottom surface of the chisel prism 1704, as shown. In operation, the chisel prism 1704 reflects the first optical input signal from the first set of optical components and the second optical input signal from the complimentary set of optical components 1703 both to the spatial light modulator 1730, and reflects the optical output signal back to the first set of optical components.

The chisel prism 1704 decreases the sensitivity of the optical filter to angular tilts of the optics. The insensitivity to tilt provides a more rugged and robust device to shock vibration and temperature changes. Further, the chisel prism 1704 provides greater tolerance in the alignment and assembly of the optical filter 1700, as well as reduces the packaging profile of the filter. To compensate for phase delay associated with each of the total internal reflection of the reflective surfaces of the prism (which will be described in greater detail hereinafter), a λ/9 wave plate 1708 is optically disposed between the prism 1704 and the λ/4 wave plate 35. An optical wedge or lens 1710 is optically disposed between the λ/4 wave plate 35 and the diffraction grating 30 for directing the output beam from the micro-mirror device 1730 to the receive pigtail 1702a of the dual fiber pigtail 1702b. The optical wedge or lens 1710 compensates for pigtail and prism tolerances.

The optical device 1700 further includes a telescope 1712 having a pair of cylindrical lens that are spaced a desired focal length. The telescope 1712 functions as a spatial beam expander that expands the input beam (approximately two times) in the spectral plane to spread the collimated beam onto a greater number of lines of the diffraction grating. The telescope 1712 may be calibrated to provide the desired degree of beam expansion. The telescope advantageously provides the proper optical resolution, permits the package thickness to be relatively small, and adds design flexibility.

A folding mirror 1714 is disposed optically between the Fourier lens 34 and the λ/4 wave plate 35 to reduce the packaging size of the optical filter 1700.

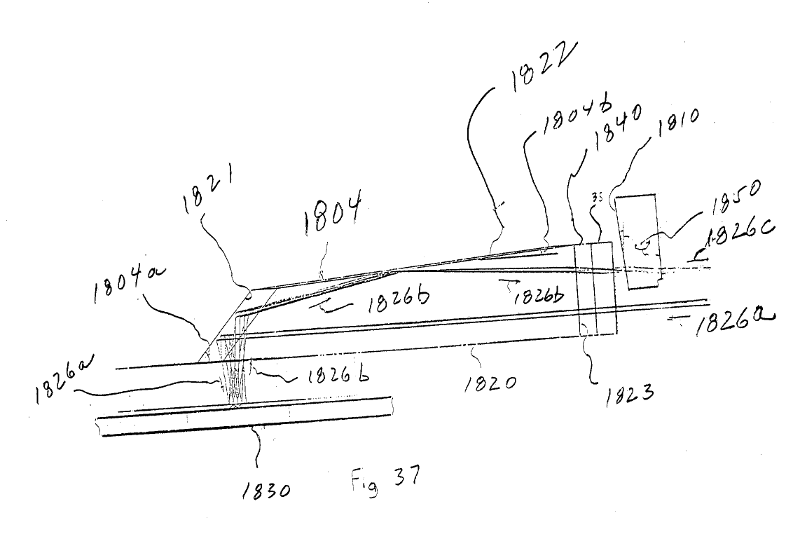

### FIG. 36

FIG. 36 shows another embodiment of a tilt-insensitive reflective assembly 1800 having a specially shaped prism 1804 in combination with a micro-mirror device 1830. Unlike an ordinary 45 degree total internal reflection (TIR) prism, in this embodiment the back surface of the chisel prism 1704 is cut at approximately a 48 degree angle relative to the bottom surface of the chisel prism 1704. The top surface of the chisel prism 1704 is cut at a 4 degree angle relative to the bottom surface to cause the light to reflect off the top surface via total internal reflection. The front surface of the chisel prism 1704 is cut at a 90 degree angle relative to the bottom surface. The chisel prism 1704 therefore provides a total of 4 surface reflections in the optical assembly (two TIRs off the back surface, one TIR off the micromirror device 1730, and one TIR off the top surface.)

In order to remove the manufacturing tolerances of the prism angles, a second smaller compensating prism or wedge 1810 (or wedge), having a front surface cut at a shallow angle (e.g., as 10 degrees) with respect to a back surface, may also be used. Slight tilting or pivoting about a pivot point of the compensation wedge 1810 causes the light beam to be pointed in the correct direction for focusing on the receive pigtail 1802.

The combination of the chisel prism 1804 and the compensation wedge 1810 allows for practical fabrication of optical devices that spread a beam out over a significant area and therefore onto a plurality of micromirrors, while keeping the optical system robust to tilt errors introduced by vibration or thermal variations.

In FIG. 37, the input light rays 1826a first pass through the λ/4 wave plate 35 and the λ/9 wave plate 1840. The input rays 1826a reflect off the back surface 1821 of the prism 1804 the micro-mirror device 1830. The rays 1826b then reflect off the micromirror device 1830 back to the back surface 1821 of the prism 1804. The rays 1826b then reflect off the top surface 1822 for a total of 4 surfaces (an even number) and passes through the front surface 1823 of the prism 1804. The rays 1826b then pass back through the λ/4 wave plate 35 and the λ/9 wave plate 1840 to the wedge 1810. The wedge 1810 redirects the output rays 1826c to the receive pigtail 1802 (FIG. 39 of the dual fiber pigtails 1802. As shown by arrows 1851, the wedge 1810 may be pivoted about its long axis 1850 during assembly to slightly steer the output beam 1826c to the receive pigtail 1802 with minimal optical loss by removing manufacturing tolerances of the chisel prism.

In FIG. 36, the prism 1804 (with wave plates 35, 1840 mounted thereto) and the micro-mirror device 1830 are mounted or secured in fixed relations to each other. The prism 1804 and micro-mirror device 1830 are tilted a predetermined angle off the axis of the input beam 614 (e.g., approximately 9.2 degrees) to properly direct the input beam onto the micromirrors of the micromirror device, as described hereinbefore. The wedge 1810 however is perpendicular to the axis of the input beam 1826a. Consequently, the receive pigtail of the dual fiber pigtail 1802 is rotated a predetermined angle (approximately 3 degrees) from a vertically aligned position with the transmit pigtail. Alternatively, the wedge 1810 may be rotated by the same predetermined angle as the prism and the micromirror device (e.g., approximately 9.2 degrees) from the axis of the input beam. As a result, the receive pigtail of the dual pigtail assembly 1802 may remain vertically aligned with transmit pigtail.

While the cross-connect device has been described as switching a pair of channels of a WDM input signal(s), the present invention contemplates selectively switching any group of channels. For example, every third, fourth, fifth or sixth channel may be switched, every other group of channels of a WDM signal(s) may be switched, or any other periodic or aperiodic pattern desired.

### The Scope of the Invention

The dimensions and geometries for any of the embodiments described herein are merely for illustrative purposes and, as much, any other dimensions may be used if desired, depending on the application, size, performance, manufacturing requirements, or other factors, in view of the teachings herein.

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein without departing from the spirit and scope of the present invention.

What is claimed is:

1. An optical cross-connect including an optical arrangement for receiving two or more optical signals, each optical signal having one or more optical bands or channels, and including a spatial light modulator having a micro-mirror device with an array of micro-mirrors for reflecting the two or more optical signals provided thereon, characterized in that
the optical arrangement comprises a free optic configuration having one or more light dispersion elements for separating the two or more optical signals so that each optical band or channel is reflected by a respective plurality of micro-mirrors to selectively switch the one or more optical bands or channels between the two or more optical signals.

2. An optical cross-connect according to claim 1, wherein the one or more light dispersion elements include either a diffraction grating, an optical splitter, a holographic device, a prism, or a combination thereof.

3. An optical cross-connect according to claim 2, wherein the diffraction grating is a blank of polished fused silica or glass with a reflective coating having a plurality of grooves either etched, ruled or suitably formed thereon.

4. An optical cross-connect according to claim 2, wherein the diffraction grating is tilted and rotated approximately 90° in relation to the spatial axis of the spatial light modulator.

5. An optical cross-connect according the claim 1, wherein the spatial light modulator is programmable for reconfiguring the optical cross-connect by changing a switching algorithm that drives the array of micro-mirrors.

6. An optical cross-connect according the claim 1, wherein the array of micro-mirrors includes a multiplicity of micro-mirrors that are separately controllable for tilting on an axis depending on a control signal in accordance with a switching algorithm.

7. An optical cross-connect according the claim 1, wherein the two or more optical signals include a wavelength division multiplexed (WDM) optical signal having a plurality of wavelengths and a corresponding plurality of optical bands or channels, each optical channel reflecting off a respective group of micro-mirrors of the micro-mirror device.

8. An optical cross-connect according the claim 2, wherein the spatial light modulator is reconfigurable by statically or dynamically modifying the switching algorithm for changing channel spacing, the shape of the light beam, or the center wavelength of the light beam of reflected optical signals.

9. An optical cross-connect according the claim 5, wherein the switching algorithm is based on the wavelength of the optical signal and the one or more optical bands or channels being switched.

10. An optical cross-connect according the claim 7, wherein the respective group of micro-mirrors are collectively tilted to reflect channels in the two or more optical signals.

11. An optical cross-connect according the claim 1, wherein each micro-mirror is tiltable in either a first position or a second position along an axis either parallel to the spectral axis of the micro-mirror device, parallel to the spatial axis of the micro-mirror device, or at an angle of 45° in relation to the spatial axis.

12. An optical cross-connect according the claim 1, wherein the optical arrangement includes one or more optical portions that provide the two or more optical signals to the spatial light modulator.

13. An optical cross-connect according the claim 12, wherein the one or more optical portions include either one or more circulators, one or more capillary tubes, or a combination thereof.

14. An optical cross-connect according the claim 13, wherein the one or more optical portions provide the two or more optical signals to the spatial light modulator.

15. An optical cross-connect according the claim 13, wherein the one or more circulators includes a pair of circulators.

16. An optical cross-connect according the claim 13, wherein the one or more capillary tubes includes a pair of capillary tubes.

17. An optical cross-connect according the claim 13, wherein the one or more circulators includes a three port circulator.

18. An optical cross-connect according the claim 12, wherein the one or more optical portions include a pair of optical portions, including one optical portion for providing one optical signal to the spatial light modulator, and another optical portion for providing another optical signal to the spatial light modulator.

19. An optical cross-connect according the claim 12, wherein the one or more optical portions include a collimator, a reflective surface, a dispersion device, a bulk lens, or a combination thereof.

20. An optical cross-connect according the claim 19, wherein the collimator includes either an aspherical lens, an achromatic lens, a doublet, a GRIN lens, a laser diode doublet, or a combination thereof.

21. An optical cross-connect according the claim 19, wherein the reflective surface includes a mirror.

22. An optical cross-connect according the claim 19, wherein the reflective surface is curved.

23. An optical cross-connect according the claim 19, wherein the bulk lens includes a Fourier lens.

24. An optical cross-connect according the claim 12, wherein the one or more optical portions provide the two or more optical as different channels having different wavelengths on the spatial light modulator.

25. An optical cross-connect according the claim 24, wherein the different channels have a desired cross-sectional geometry, including elliptical, rectangular, square or polygonal.

26. An optical cross-connect according the claim 24, wherein the spatial light modulator is configured so one group of channels is spaced at 100 GHz and another group of channels is spaced at 50 GHz.

27. An optical cross-connect according the claim 12, wherein the one or more optical portions further comprise a further optical portion for receiving the two or more optical signals from the spatial light modulator and providing these same optical signals back to the spatial light modulator.

28. An optical cross-connect according the claim 27, wherein the further optical portion includes a pair of reflective surfaces and lens, one reflective surface arranged at one focal length in relation to one lens and the spatial light modulator, and another reflective surface arranged at a different focal length in relation to another lens and the spatial light modulator.

29. An optical cross-connect according the claim 28, wherein the one focal length is twice the length of the other focal length.

30. An optical cross-connect according the claim 27, wherein the further optical portion includes a single reflective surface and lens arrangement.

31. An optical cross-connect according the claim 30, wherein a single lens is arranged between a reflective surface and the spatial light modulator.

32. An optical cross-connect according to claim 12, wherein the one or more optical portions include one or more optical PDL devices for minimizing polarization dependence loss (PDL).

33. An optical cross-connect according to claim 32, wherein one optical PDL device is arranged between a capillary tube and a collimator in the optical arrangement, and another optical PDL device is arranged between a bulk lens and the spatial light modulator.

34. An optical cross-connect according to claim 33, wherein the one or more optical PDL devices include a pair of optical PDL devices.

35. An optical cross-connect according to claim 33, wherein the one or more optical PDL devices includes one optical PDL device having a polarization splitter for splitting each channel into a pair of polarized light beams and a rotator for rotating one of the polarized light beams of each optical channel.

36. An optical cross-connect according to claim 35, wherein the one or more optical PDL devices includes another optical PDL device having a rotator for rotating one of the previously rotated and polarized light beams of each optical channel and a polarization splitter for combining the pair of polarized light beams of each channel.

37. An optical cross-connect according to claim 35, wherein the one or more optical PDL devices includes a λ/4 plate.

38. An optical cross-connect according to claim 2, wherein the diffraction grating has a low dispersion loss for minimizing the affect of polarization dispersion loss.

39. An optical cross-connect according to claim 12, wherein the optical arrangement includes a chisel prism having multiple faces for internally reflecting the one or more optical signals.

40. An optical cross-connect according to claim 39, wherein the multiple faces include at least a front face, first and second beveled front faces, a rear face and a bottom face.

41. An optical cross-connect according to claim 39, wherein optical light from first or second optical portions passes through one or more faces of the chisel prism, reflects off one or more internal surfaces of the chisel prism, reflects off the spatial light modulator, again reflects off the one or more internal surfaces of the chisel prism, and passes back to the first or second optical portions.
